(19) United States
(12) Patent Application Publication
(10) Pub. No.: US 2026/0090526 A1
(43) Pub. Date: Apr. 2, 2026

(54) REPTILE TERRARIUM AND STACKABLE REPTILE TERRARIUM

(71) Applicant: DA VINCI PET INTELLIGENCE (SHENZHEN) CO., LTD., SHENZHEN CITY (CN)

(72) Inventor: ZETAO GUO, JINZHONG CITY (CN)

(21) Appl. No.: 19/234,283

(22) Filed: Jun. 11, 2025

(30) Foreign Application Priority Data
Sep. 29, 2024 (CN) 202422391547.0

(51) Int. Cl. A01K 63/00; A01K 1/00

(52) U.S. Cl. CPC A01K 63/003; A01K 1/0058

(57) ABSTRACT

A reptile terrarium and a stackable reptile terrarium relate to the technical field of pet products. The reptile terrarium includes: a base, a support column, a top plate, a side plate, and a door plate. The base is provided with an open top; the support column is detachably assembled on an upper peripheral side of the base; the side plate is detachably assembled between two adjacent support columns; the top plate is detachably assembled at one end of the support column far away from the base, and the top plate is provided with ventilation holes; and the door plate is positioned between two adjacent support columns and is movably assembled between the top plate and/or the base to open or close the reptile terrarium. A stackable reptile terrarium includes: a plurality of reptile terrariums and an upright column detachably assembled between two adjacent reptile terrariums.

### FIELD OF THE DISCLOSURE

The present invention relates to the technical field of pet products, and specifically, to a reptile terrarium and a stackable reptile terrarium.

### BACKGROUND OF THE DISCLOSURE

A reptile terrarium is a breeding container specially designed for reptiles such as lizards, snakes, and turtles, which not only simulates the natural habitat of reptiles to provide with a suitable and safe living environment, but also facilitates breeders to observe the dynamics of reptiles and increase the ornamental value. According to most existing reptile terrariums, the terrarium body is bonded together with glass and colloid, which requires high bonding technology between glasses. Therefore, manufacturers often need to deliver the terrarium as a whole, resulting in high packaging and transportation costs and causing damage during transportation, deformation of the terrarium body, or water leakage in the terrarium body. However, some detachable reptile terrariums that facilitate the transportation and assembly by consumers often have problems such as large seams between a base and side plates or among side plates of the terrarium body, and uneven joints. These problems easily lead to residual excrement or other impurities from the reptiles, making the cleaning and maintenance of the reptile terrariums difficult and affecting the breeding environment of the reptiles.

### SUMMARY OF THE DISCLOSURE

In view of the defects and shortcomings in the prior art, an objective of the present invention is to provide a reptile terrarium and a stackable reptile terrarium, which have the advantages of being disassembled and assembled and convenient to clean and maintain.

To achieve the foregoing objective, the present invention adopts the following technical solution. A reptile terrarium includes: a base, having an open top, wherein an inner side wall of the base is provided as an inclined surface inclined toward the inside of the base; a support column, detachably assembled on an upper peripheral side of the base, wherein a plurality of the support columns are provided, and first clamping grooves are provided at two sides of each support column; a side plate, detachably assembled between two adjacent support columns, wherein two sides of the side plate are placed in corresponding first clamping grooves, and a plurality of the side plates are provided; a top plate, detachably assembled at one end of the support column far away from the base, wherein the top plate is provided with ventilation holes; and a door plate, positioned between two adjacent support columns, movably assembled between the top plate and/or the base, and used to open or close the reptile terrarium.

According to a further configuration of the present invention, a first limit stop bar extending upward is provided on one surface of the base abutting against the side plate, a first limit stop plate is provided on an inner side wall of one end of the base close to the side plate, and the first limit stop bar cooperates with the first limit stop plate to prevent the side plate from tipping over.

According to a further configuration of the present invention, a second limit stop bar extending downward is provided on one surface of the top plate facing the side plate, a second limit stop plate is provided on an inner side wall of one surface of the top plate facing the side plate, and the second limit stop bar cooperates with the second limit stop plate to prevent the side plate from tipping over.

According to a further configuration of the present invention, a second clamping groove is provided at one end of the support column facing the base, wherein a limiting column corresponding to the second clamping groove is provided on the base, and the second clamping groove cooperates with the limiting column to fix the support column at a set position.

According to a further configuration of the present invention, the top plate includes: a top frame, a ventilation plate fixedly assembled at one side of the top frame facing the support column and having a plurality of ventilation holes, and an opening component slidably assembled at one side of the top frame facing the ventilation plate; the opening component includes: a slider and a slider protrusion provided on one surface of the slider facing the top frame; the top frame is provided with a first through hole, the slider protrusion is exposed from the first through hole, the slider is provided with a second through hole, and the ventilation plate is provided with a third through hole corresponding to the position of the first through hole; and when the slider protrusion is pushed and the slider slides to a set position, the first through hole, the second through hole, and the third through hole are connected to form an opening channel.

According to a further configuration of the present invention, a first stroke plate is provided at one surface of the top frame facing the ventilation plate and positioned at one side of the first through hole, the first stroke plate is provided with a plurality of arc-shaped grooves in succession, and the slider is provided with an elastic protrusion; and the elastic protrusion cooperates with the arc-shaped groove to limit an opening width of the opening channel.

According to a further configuration of the present invention, a second stroke plate is provided at one surface of the top frame facing the ventilation plate and positioned at another side of the first through hole, and the second stroke plate is provided with a limiting groove; the slider is also provided with a limit stopper corresponding to the limiting groove, and the limiting groove cooperates with the limit stopper to limit a sliding range of the slider.

According to a further configuration of the present invention, a sliding rail is arranged at one side of the top frame facing the slider, and a sliding groove cooperating with the sliding rail is provided at one side of the slider facing the top frame; and the sliding rail cooperates with the sliding groove to limit a sliding track of the slider.

According to a further configuration of the present invention, one end of the door plate is rotatably connected to the top frame by a first rotating assembly, another end is rotatably connected to the base by a second rotating assembly, and the first rotating assembly and the second rotating assembly are arranged on the same vertical line.

According to a further configuration of the present invention, the first rotating assembly includes: a fixed plate provided at an outer side of the door plate, a mounting column provided on one surface of the fixed plate facing the door plate and used to mount the fixed plate on the door plate, an extension plate provided on an upper side of the fixed plate and overlapped on an upper edge of the door plate, a rotation shaft provided close to a rotating end of the extension plate, extending toward one surface of the top frame and used to be rotatably assembled with the top frame, a shaft sleeve provided at a peripheral side of the rotation shaft, and a fastener used to cooperate with the mounting column to assemble the fixed plate on the door plate.

According to a further configuration of the present invention, the first rotating assembly includes: a first mounting member provided at an outer side of the door plate, an assembly column provided on one surface of the first mounting member facing the door plate and used to assemble the first mounting member on the door plate, an extension member provided on an upper side of the first mounting member, extending toward the door plate and overlapped on an upper edge of the door plate, a rotating shaft provided at a top side of the extension member close to a rotating end, extending toward the top frame and used to be rotatably assembled with the top frame, a second mounting member provided on an inner side of the door plate and used to cooperate with the first mounting member to drive the door plate to rotate, and a locking member used to cooperate with the mounting column to lock the first mounting member, the second mounting member and the door plate.

According to a further configuration of the present invention, an assembly groove is formed on the extension member, and an assembly protrusion cooperating with the assembly groove is arranged on the second mounting member; and the assembly groove cooperates with the assembly protrusion, so that the extension member is in clamping fit with the second mounting member.

According to a further configuration of the present invention, the reptile terrarium further includes: a door lock assembly assembled between a free end of the door plate and the top plate or the base, and the door lock assembly includes: a mounting plate, wherein a movable hole is formed at one side of the mounting plate; a first support plate, arranged on the mounting plate and positioned at two sides of the movable hole; a latch bolt, movably assembled at one side of the first support plate, wherein the latch bolt reciprocates along one side of the first support plate; and a linkage member; wherein the linkage member includes: a linkage member body rotatably assembled on the first support plate, a first bending part provided at one end of the linkage member body and bending toward one side of the latch bolt, and a second bending part provided at another end of the linkage member body, passing through the movable hole and extending toward a direction far away from the mounting plate; a tail end of the second bending part bends toward one side of the latch bolt; the second bending part cooperates with the latch bolt to unlock or lock the door plate; when a user closes the door plate, the door plate pushes the second bending part to rotate inwards, so that the first bending part pushes the latch bolt toward a direction far away from the mounting plate, and the door plate is locked between the latch bolt and the second bending part; and when the latch bolt is pushed toward a direction of the first bending part, the latch bolt pushes the first bending part to rotate inwards, so that the second bending part rotates outwards, and then the second bending part pushes the door plate outwards to unlock the door plate.

According to a further configuration of the present invention, a movable groove for the latch bolt to reciprocate is provided on the mounting plate and close to one side of the first support plate; first limiting protrusions protruding toward two sides of the movable groove are provided at two sides of the latch bolt; and the first limiting protrusion cooperates with the mounting plate to prevent the latch bolt from falling out.

According to a further configuration of the present invention, the door lock assembly further includes: a second support plate provided on the mounting plate and close to one side of the latch bolt, a third support plate provided on the mounting plate and close to one side of the latch bolt, and a limiting member slidably assembled between the second support plate and the third support plate; and the limiting member is used to limit the movement of the latch bolt toward the first bending part.

According to a further configuration of the present invention, a latch bolt limiting groove is provided at one side of the limiting member close to the latch bolt.

According to a further configuration of the present invention, the limiting member includes a limiting member body, a first sliding bar provided at one side of the limiting member body and a second sliding bar provided at another side of the limiting member body; the first sliding bar and the second sliding bar are slidably assembled on the second support plate and the third support plate respectively; and the first sliding bar cooperates with the second sliding bar, so that the limiting member body can slide relative to the second support plate and the third support plate.

According to a further configuration of the present invention, a first extension plate extending away from the limiting member body is provided at one side of the first sliding bar far away from the limiting member body; a second extension plate vertically extending toward the mounting plate is provided on a bottom side of the first extension plate; a first arc-shaped protrusion is provided at one side of the second extension plate facing the second support plate; and a second arc-shaped protrusion cooperating with the first arc-shaped protrusion is provided at one side of the second support plate facing away from the third support plate.

To achieve another of the above objectives, the present invention adopts the following technical solution. A stackable reptile terrarium includes: a plurality of the reptile terrariums and an upright column detachably assembled between two adjacent reptile terrariums; wherein the reptile terrariums are placed up and down; a plurality of upright columns are provided, one end of the upright column is mounted on a bottom of the upper reptile terrarium and another end is mounted on a top of the lower reptile terrarium.

With the adoption of the foregoing technical solutions, the present invention has the following beneficial effects. Compared with the existing reptile terrariums that are disassembled and assembled by splicing a base with surrounding parts, the reptile terrarium in the present invention is assembled with a separate base and surrounding side plates, door plate and top plates, so that the terrarium body can be disassembled and assembled while preventing water seepage from the base. Compared with the existing reptile terrariums that are provided with clamping grooves on a base for mounting side plates, the reptile terrarium in the present invention is provided with a first clamping groove on a support column, and two sides of the side plate are placed in the first clamping grooves corresponding to the support columns to mount the side plates. In addition, an inner wall of a base is provided with an inclined surface to facilitate the excrement of the reptiles to flow into the base along the inclined surface, which is convenient for users to clean and maintain, and avoids the situation that the health of reptiles, caused by the fact of the breeding bacteria in the reptile terrarium, is threatened by the fact that the user cannot clean the excrement flowing into the clamping groove on the base when the reptiles excrete on the side.

### BRIEF DESCRIPTION OF THE DRAWINGS

To describe the technical solutions in embodiments of the present invention or in the conventional technology more clearly, the following briefly describes the accompanying drawings for describing embodiments or the conventional technology. It is clear that the accompanying drawings in the following description show merely some embodiments of the present invention, and a person of ordinary skill in the art may still derive other drawings from these accompanying drawings without creative efforts.

FIG. 1 is a schematic diagram of the structure of a reptile terrarium;

FIG. 2 is a schematic diagram of the structure of a reptile terrarium with two side plates and a support column hidden;

FIG. 3 is an exploded schematic diagram of the structure of a reptile terrarium;

FIG. 4 is a schematic diagram of the structure of a reptile terrarium from a top view;

FIG. 5 is a cross-sectional view of a reptile terrarium in a direction of A-A from a top view;

FIG. 6 is a schematic diagram of the structure of a support column;

FIG. 7 is a schematic diagram of the structure of closing an opening channel with a top plate hiding a ventilation plate;

FIG. 8 is a schematic diagram of the structure of opening an opening channel with a top plate hiding a ventilation plate;

FIG. 9 is a schematic diagram of the structure of an opening component;

FIG. 10 is a partial schematic diagram of part A of a top frame;

FIG. 11 is a partially enlarged schematic diagram of part A of a top frame;

FIG. 12 is a schematic diagram of the structure of a reptile terrarium with a door plate opened from another perspective;

FIG. 13 is an exploded schematic diagram of the structure of a first rotating assembly;

FIG. 14 is a schematic diagram of the structure of a stackable reptile terrarium;

FIG. 15 is a schematic diagram of the structure of a stackable reptile terrarium from a bottom perspective;

FIG. 16 is a schematic diagram of the structure of a reptile terrarium according to another embodiment;

FIG. 17 is a schematic diagram of the structure of a reptile terrarium according to another embodiment from another perspective;

FIG. 18 is a schematic diagram of the structure of a reptile terrarium according to another embodiment with a door plate opened;

FIG. 19 is an exploded schematic diagram of the structure of a reptile terrarium according to another embodiment;

FIG. 20 is a schematic diagram of the structure of a stackable reptile terrarium according to another embodiment;

FIG. 21 is a schematic diagram of the structure of a top plate according to another embodiment;

FIG. 22 is an exploded schematic diagram of the structure of a top plate according to another embodiment;

FIG. 23 is a partial schematic diagram of a portion B of a top frame cooperating with an opening component to close an opening channel according to another embodiment;

FIG. 24 is a partially enlarged schematic diagram of the portion B in FIG. 23;

FIG. 25 is a schematic diagram of the structure of a top frame cooperating with an opening component to open an opening channel according to another embodiment;

FIG. 26 is a schematic diagram of the structure of an opening component according to another embodiment;

FIG. 27 is a schematic diagram of the structure of a first rotating assembly according to another embodiment;

FIG. 28 is a schematic diagram of the structure of a door lock assembly;

FIG. 29 is a schematic diagram of the structure of a door lock assembly from another perspective;

FIG. 30 is a schematic diagram of the structure of a door lock assembly from a front view;

FIG. 31 is a schematic diagram of the structure of a first limiting protrusion cooperating with a second limiting protrusion in the door lock assembly;

FIG. 32 is a schematic diagram of the structure of a door lock assembly in a state where a limiting member limits a stop plate from moving toward a first bending part;

FIG. 33 is an exploded schematic diagram of the structure of a door lock assembly;

FIG. 34 is a schematic diagram of the structure of a mounting plate;

FIG. 35 is a schematic diagram of the structure of a stop plate; and

FIG. 36 is a schematic diagram of a structure of a limiting member.

Descriptions of reference numerals are as follows: 100: base; 110: first limit stop bar; 120: first limit stop plate; 130: limiting column; 140: bottom assembly groove; 200: support column; 210: first clamping groove; 220: second clamping groove; 300: top plate; 310: top frame; 311: second limit stop bar; 312: second limit stop plate; 313: first through hole; 314: first stroke plate; 3141: arc-shaped groove; 315: second stroke plate; 3151: limiting groove; 316: top assembly groove; 317: buckle cover; 320: ventilation plate; 321: ventilation hole; 322: third through hole; 330: opening component; 331: slider; 3311: second through hole; 3312: elastic protrusion; 3313: limit stopper; 332: slider protrusion; 333: sliding groove; 400: side plate; 500: door plate; 600: first rotating assembly; 610: fixed plate; 620: mounting column; 630: extension plate; 640: rotation shaft; 650: shaft sleeve; 660: fastener; 700: second rotating assembly; 800: locking switch; 910: excrement; 920: upright column; 930: first mounting member; 940: assembly column; 950: extension member; 951: assembly groove; 960: rotating shaft; 970: second mounting member; 971: assembly protrusion; 980: locking member; 990: sliding rail; 1100: mounting plate; 1110: movable hole; 1120: movable groove; 1200: first support plate; 1300: latch bolt; 1310: first limiting protrusion; 1311: first guiding inclined surface; 1312: second guiding inclined surface; 1320: first avoidance groove; 1330: handle; 1400: linkage member; 1410: linkage member body; 1420: first bending part; 1430: second bending part; 1500: clamping column; 1510: second limiting protrusion; 1511: third guiding inclined surface; 1512: fourth guiding inclined surface; 1600: second support plate; 1610: second arc-shaped protrusion; 1700: third support plate; 1800: limiting member; 1810: limiting member body; 1811: button protrusion; 1812: latch bolt limiting groove; 1813: second avoidance groove; 1820: first sliding bar; 1830: second sliding bar; 1840: first extension plate; 1850: second extension plate; and 1851: first arc-shaped protrusion.

### DETAILED DESCRIPTION OF THE EXEMPLARY EMBODIMENTS

The present invention is further described in detail below in conjunction with the accompanying drawings.

This specific embodiment is merely an explanation of the present invention, but not a limitation of the present invention. After reading this specification, those skilled in the art can make non-creative modifications to this embodiment based on a requirement, and these modifications are all protected by the Patent Law as long as they are within the scope of the claims of the present invention.

### Embodiment 1

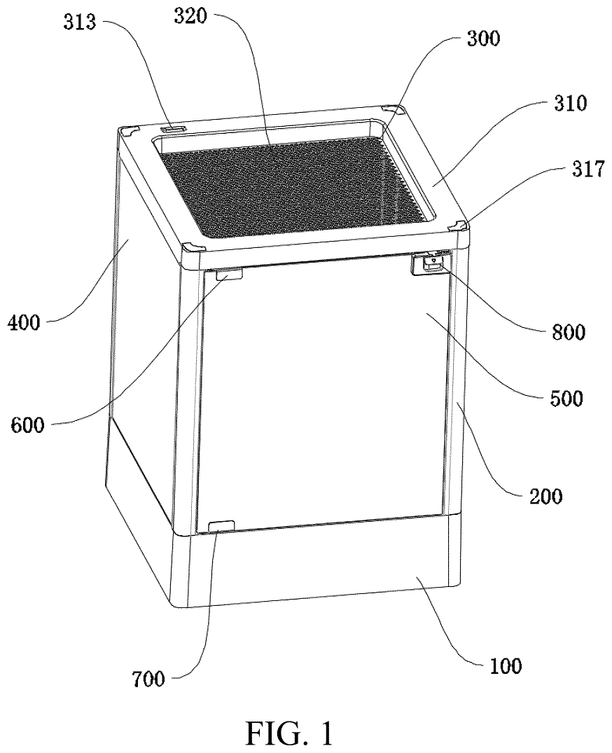

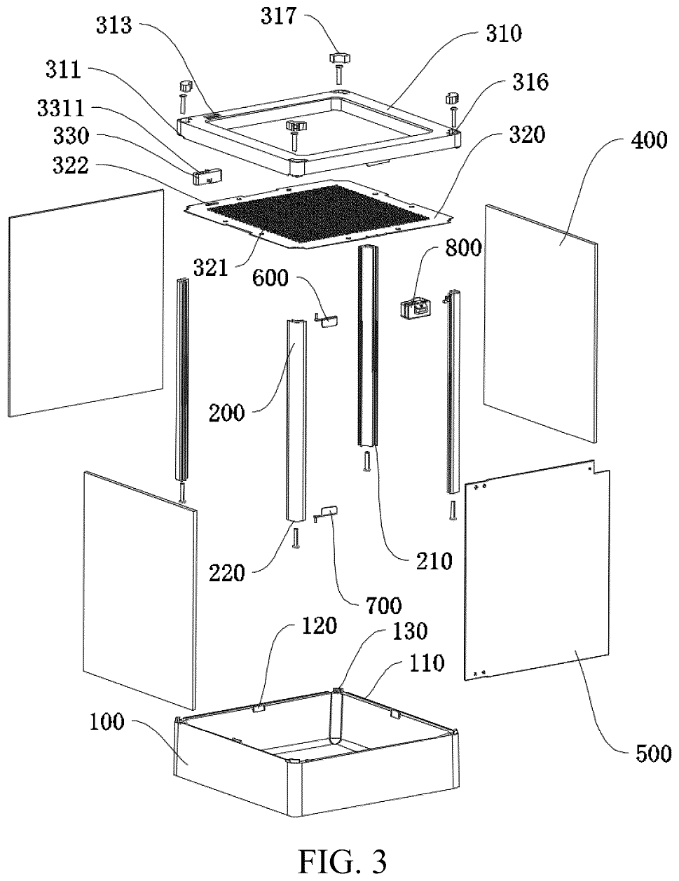

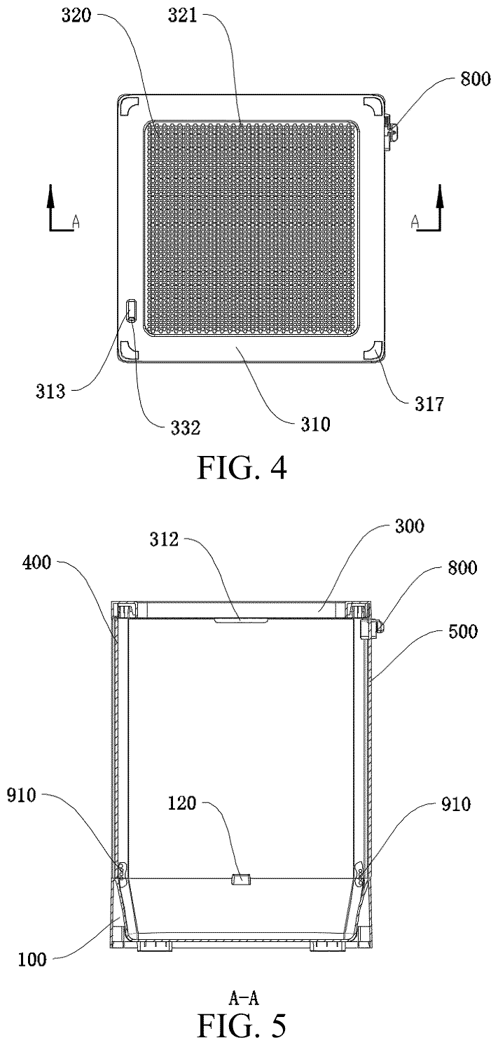

This embodiment relates to a reptile terrarium, which includes, as shown in FIGS. 1 to 3, a base 100, a support column 200, a top plate 300, a side plate 400, and a door plate 500. The base 100 is provided with an open top, and an inner side wall of the base 100 is provided as an inclined surface inclined toward the inside of the base 100. A base of the existing reptile terrarium is formed by splicing with surrounding parts, and there is a certain splicing gap in a bottom space, which may cause water leakage during the process of raising reptiles. Although some reptile terrariums are adhered by silicone glue, the glue is prone to mold or aging during long-term use. The base 100 in this reptile terrarium is a single whole, which can meet the breeding conditions of more types of reptiles, avoid the problems of bottom leakage, and aging and mildew of glue, and has a good waterproof effect. In addition, in this embodiment, the base 100 is integrally formed of plastic, so that the base is light in weight, resistant to falling and not prone to leakage, and can be used by injecting water into the base 100, thereby ensuring the convenience of household use. The support column 200 is detachably assembled on an upper peripheral side of the base 100, a plurality of the support columns are provided, and first clamping grooves 210 are provided at two sides of each support column 200. In this embodiment, four support columns 200 are provided, which are respectively provided at four corners of the upper peripheral side of the base 100 to support the top plate 300. The top plate 300 is detachably assembled at one end of the support column 200 far away from the base 100 to prevent the reptiles from climbing out, and a ventilation hole 321 is provided on the top plate 300 to ensure air circulation inside the reptile terrarium. The side plate 400 is detachably assembled between two adjacent support columns 200, two sides of each side plate 400 are placed in the corresponding first clamping grooves 210, one end of each side plate 400 abuts against the base 100, and another end of each side plate abuts against the top plate 300; and a plurality of side plate 400 are provided to play a partial supporting role. The existing reptile terrarium is provided with a clamping groove on the base 100 for mounting the side plate 400. When the reptiles excrete on the side, the excrement 910 falls into the clamping groove and cannot be cleaned. In this embodiment, referring to FIGS. 3 to 5, the side plate 400 is mounted in the first clamping groove 210 of the support column 200 on the upper peripheral side of the base 100, so that the mounting, disassembly and assembly of the side plate 400 are simple and convenient. This ensures that the side plate 400 and the inner side wall of the base 100 are connected without a clamping groove or an obvious seam, and avoids the situation that the reptile health is affected due to bacteria breeding inside the terrarium body caused by the fact that sanitary dead angles exist between the base 100 and the side plates 400 and excrement 910 of the reptiles or other residual sundries cannot be cleaned completely. In this embodiment, three side plates 400 are provided. In addition, the door plate 500 is positioned between two adjacent support columns 200, is movably assembled between the top plate 300 and/or the base 100, and is used to open or close the reptile terrarium. In this embodiment, the door plate 500 is movably assembled between the top plate 300 and the base 100. Specifically, the door plate 500 is rotatably connected between the top plate 300 and the base 100. In some embodiments, the door plate 500 is movably assembled on the top plate 300, for example, by being rotatably connected to the top plate 300, and a user may open or close the reptile terrarium by flipping and rotating the door plate 500 upward or downward. In other embodiments, the door plate 500 may also be movably assembled on the base 100.

In this embodiment, the door plate 500 is opened on the side, which is convenient for the user to directly clean the inside of the reptile terrarium and directly remove the garbage, and has the advantages of easy cleaning and convenient maintenance. In addition, the door plate 500 is made of transparent glass or acrylic material, which is convenient for the user to view and observe the status of the reptiles.

In this embodiment, the entire reptile terrarium can be disassembled and assembled, which is convenient for transportation, reduces transportation and packaging costs, and increases the user's experience of assembling the reptile terrarium. In other embodiments, the number of the support columns 200 and the side plates 400 is determined based on the base 100, the production of the manufacturer, the requirement of the user, and the like. For example, the base 100 may be configured as a hexagon, and correspondingly, five side plates 400 and six support columns 200 are provided. This is not limited herein.

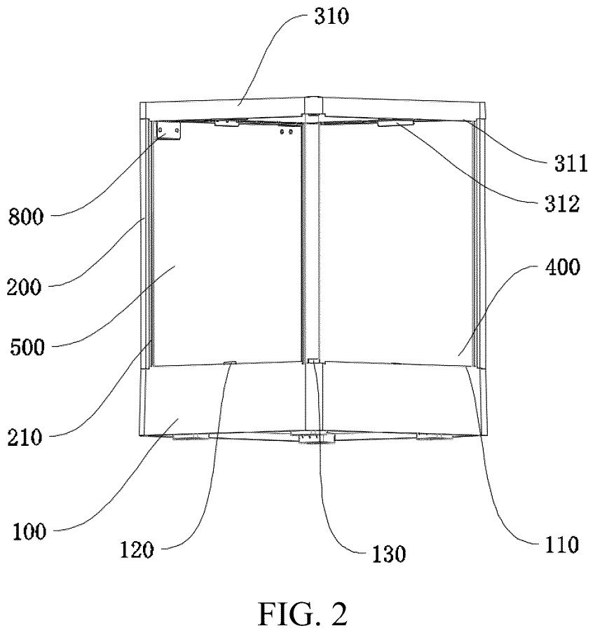

Further, referring to FIGS. 2 to 3, a first limit stop bar 110 extending upward is provided on one surface of the base 100 abutting against the side plate 400, a first limit stop plate 120 is provided on an inner side wall of one end of the base 100 close to the side plate 400, and the first limit stop bar 110 cooperates with the first limit stop plate 120 to prevent the side plate 400 from tipping over. Specifically, the first limit stop bar 110 is provided at an outer side of one surface of the base 100 abutting against the side plate 400 to prevent the side plate 400 from tipping outwards; and the first limit stop plate 120 prevents the side plate 400 from tipping inwards. Meanwhile, the first limit stop bar 110 and the first limit stop plate 120 also play a role in limiting the mounting position of the side plate 400, so as to guide the user to mount the side plate 400 at a set position. The first limit stop bar 110 is provided with a guiding inclined surface, so that the side plate 400 may be mounted more smoothly.

In this embodiment, referring to FIGS. 2 to 3, a second limit stop bar 311 extending downward is provided on one surface of the top plate 300 facing the side plate 400, a second limit stop plate 312 is provided on an inner side wall of one surface of the top plate 300 facing the side plate 400, and the second limit stop bar 311 cooperates with the second limit stop plate 312 to prevent the side plate 400 from tipping over. Specifically, the second limit stop bar 311 is provided at an outer side of the top plate 300 facing the side plate 400 to prevent the side plate 400 from tipping outwards; the second limit stop plate 312 prevents the side plate 400 from tipping inwards. Meanwhile, the second limit stop bar 311 and the second limit stop plate 312 also play a role in limiting the mounting position of the side plate 400.

In this embodiment, the first clamping groove 210, the first limit stop bar 110, the second limit stop bar 311, the first limit stop plate 120, and the second limit stop plate 312 on the two sides of the support column 200 cooperate to facilitate the mounting of the side plate 400, and also play a role in fixing the side plate 400 and preventing the side plate 400 from tipping and shifting.

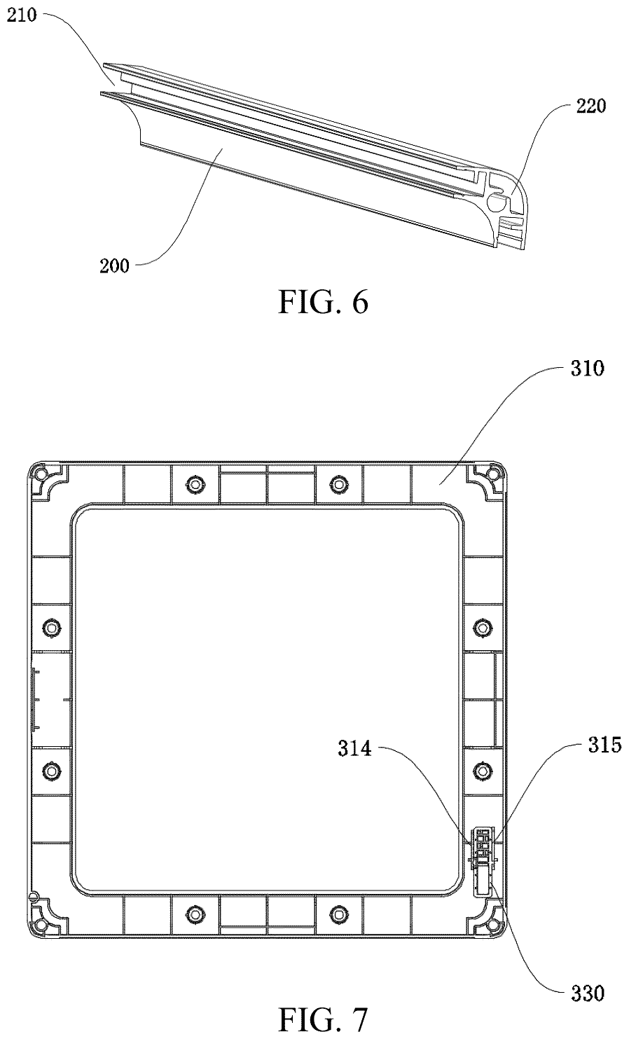

Further, referring to FIGS. 3 and 6, a second clamping groove 220 is provided at one end of the support column 200 facing the base 100, wherein a limiting column 130 corresponding to the second clamping groove 220 is provided on the base 100, and the second clamping groove 220 cooperates with the limiting column 130 to fix the support column 200 at a set position. Meanwhile, this makes the support column 200 less likely to move and loosen, thereby ensuring the overall stability of the reptile terrarium and the safety of the reptile in the terrarium body. In this embodiment, the second clamping groove 220 is also provided at one end of the support column 200 facing the top plate 300, and a limiting column 130 of the top plate 300 corresponding to the second clamping groove 220 is provided on the top plate 300, and the limiting column 130 cooperates with the limiting column 130 of the top plate 300 to prevent the support column 200 from displacement and loosening.

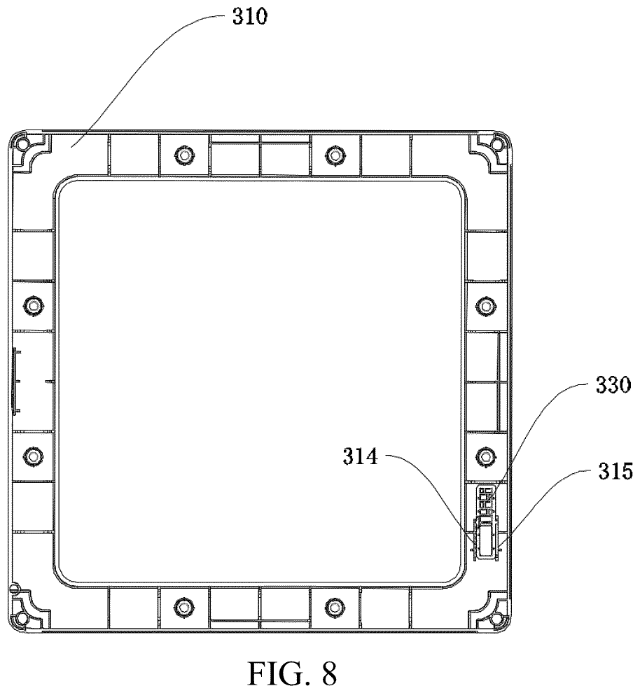

In this embodiment, referring to FIGS. 1 to 4, the top plate 300 includes: a top frame 310, a ventilation plate 320 fixedly assembled on the top frame 310 facing the support column 200 and having a plurality of ventilation holes 321, and an opening component 330 slidably assembled on the top frame 310 facing the ventilation plate 320; the opening component 330 includes: a slider 331 and a slider protrusion 332 provided on one surface of the slider 331 facing the top frame 310; the top frame 310 is provided with a first through hole 313, the slider protrusion 332 is exposed from the first through hole 313, the slider 331 is provided with a second through hole 3311, and the ventilation plate 320 is provided with a third through hole 322 corresponding to the position of the first through hole 313. Referring to FIGS. 7 to 8, when the slider protrusion 332 is pushed and the slider 331 slides to a set position, the first through hole 313, the second through hole 3311, and the third through hole 322 are connected to form an opening channel. The users may feed reptiles through the opening channel, which also increases the air circulation channel, making it easier to dissipate heat and ventilate the reptile terrarium. In addition, the opening channel may also be used as an access port for connecting cables of equipment when adding equipment inside the reptile terrarium, such as wires of a monitor, water pipes of a water pump, and a power cord. The slider protrusion 332 is exposed from the first through hole 313, which is convenient for the user to open and close the opening channel and adjust the size of the opening channel. The user only needs to simply push the slider protrusion 332 to adjust the opening channel, which is easy and quick to operate. In this embodiment, the second limit stop bar 311 is specifically provided on one surface of the top frame 310 facing the side plate 400, and the second limit stop plate 312 is specifically provided on an inner side wall of one surface of the top frame 310 facing the side plate 400. In this embodiment, a first through hole 313 is formed on a top surface of the top frame 310, and a second through hole 3311 is formed on a top surface of the slider 331.

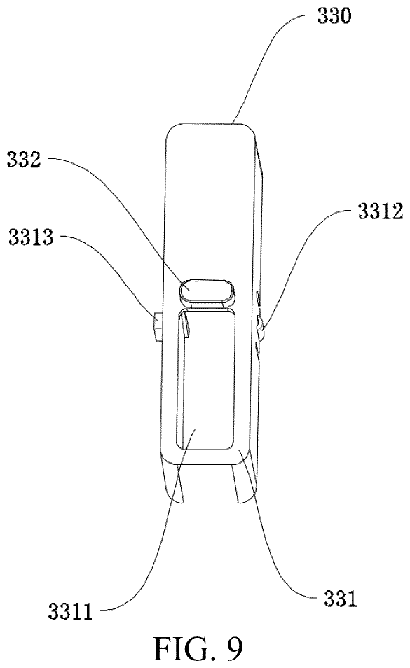

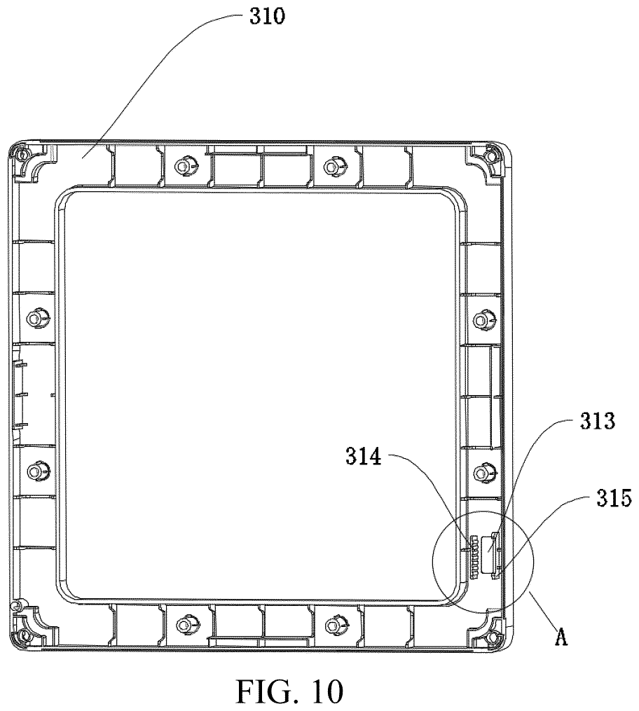

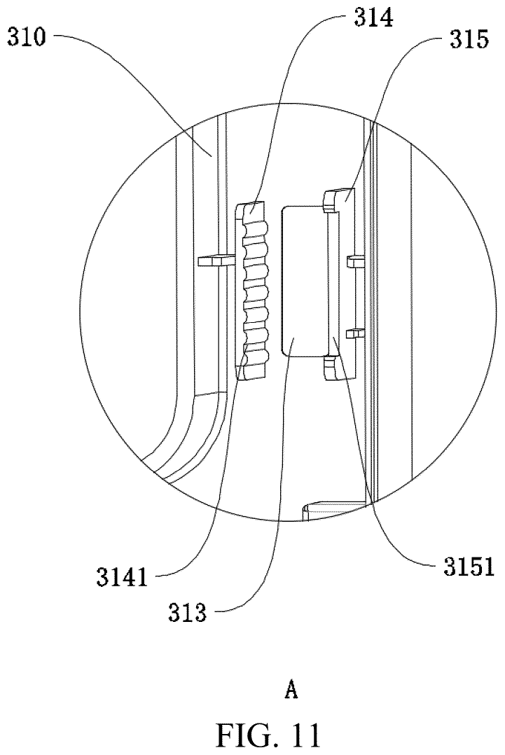

Further, referring to FIGS. 9 to 11, a first stroke plate 314 is provided at one surface of the top frame 310 facing the ventilation plate 320 and positioned at one side of the first through hole 313, the first stroke plate 314 is provided with a plurality of arc-shaped grooves 3141 in succession, and the slider 331 is provided with an elastic protrusion 3312; and the elastic protrusion 3312 cooperates with the arc-shaped groove 3141 to limit an opening width of the opening channel. Meanwhile, this arrangement makes it easy for the user to push the slider 331 to stay at different preset positions to adjust the opening width of the opening channel based on a requirement, thereby achieving precise control of the opening width of the opening channel, so that the slider 331 is not prone to accidental sliding or displacement, thereby preventing the opening width of the opening channel from being too large and causing the reptiles to accidentally climb out.

Further, referring to FIGS. 9 to 11, a second stroke plate 315 is provided at one surface of the top frame 310 facing the ventilation plate 320 and positioned at another side of the first through hole 313, and the second stroke plate 315 is provided with a limiting groove 3151; the slider 331 is also provided with a limit stopper 3313 corresponding to the limiting groove 3151, and the limiting groove 3151 cooperates with the limit stopper 3313 to limit a sliding range of the slider 331, so as to prevent the opening component 330 from being damaged due to excessive sliding.

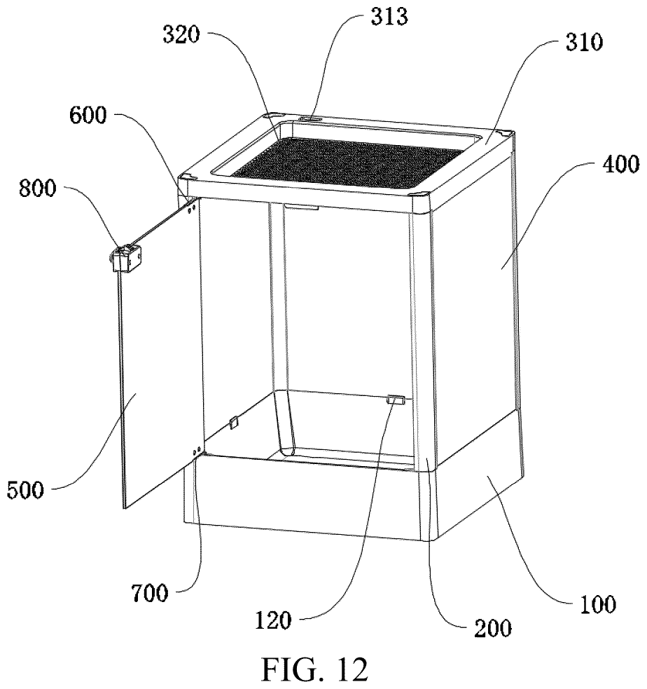

In this embodiment, referring to FIG. 12, one end of the door plate 500 is rotatably connected to the top frame 310 by a first rotating assembly 600, another end is rotatably connected to the base 100 by a second rotating assembly 700, the first rotating assembly 600 and the second rotating assembly 700 are arranged on the same vertical line, and the first rotating assembly 600 and the second rotating assembly 700 cooperate to enable the door plate 500 to rotate around the same vertical line on which the first rotating assembly 600 and the second rotating assembly 700 are provided.

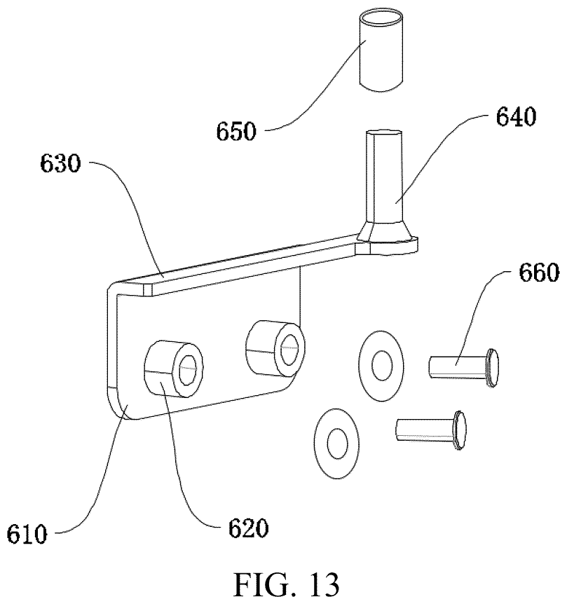

Further, referring to FIG. 3 and FIGS. 12 to 13, the first rotating assembly 600 includes: a fixed plate 610 provided at an outer side of the door plate 500, a mounting column 620 provided on one surface of the fixed plate 610 facing the door plate 500 and used to mount the fixed plate 610 on the door plate 500, an extension plate 630 provided on an upper side of the fixed plate 610 and overlapped on an upper edge of the door plate 500, a rotating shaft 640 provided close to a rotating end of the extension plate 630, extending toward one surface of the top frame 310 and used to rotate with the top frame 310, a shaft sleeve 650 provided at a peripheral side of the rotating shaft 640, and a fastener 660 used to cooperate with the mounting column 620 to assemble the fixed plate 610 on the door plate 500. Specifically, in this embodiment, the door plate 500 is provided with a mounting hole corresponding to the mounting column 620. During assembly, the mounting column 620 extends into the mounting hole in the door plate 500, the fixed plate 610 is fixed to the door plate 500 by the fastener 660, and the top frame 310 is provided with a rotating shaft hole for the rotating shaft 640 to be inserted. In this embodiment, a gasket is further sleeved on one end of the fastener 660 to fill the gap between the fastener 660 and the door plate 500. The shaft sleeve 650 is sleeved on the periphery of the rotation shaft 640, and functions to make the mutual work between the rotation shaft 640 and the hole of the rotation shaft 640 smoother and more reliable, and to increase the service life thereof. In addition, the shaft sleeve 650 replaces the traditional multi-layer screw shaft, achieving the effect of rotational damping at a low cost. In this embodiment, the second rotating assembly 700 has the same structure as the first rotating assembly 600, and includes: a fixed plate, a mounting column, an extension plate, a rotation shaft, a shaft sleeve, and a fastener.

In this embodiment, the fastener 660 is a screw. In other embodiments, the fastener 660 may also be a rivet or the like. In other embodiments, the first rotating assembly 600 and the second rotating assembly 700 may also be hinges.

Referring to FIGS. 1 and 12, in this embodiment, a locking switch 800 is provided at a free end of the door plate 500 to unlock or lock the door plate 500 to prevent the reptiles from climbing out. In this embodiment, the locking switch is used to unlock or lock the door plate 500 and the top frame 310. In other embodiments, the locking switch may also be used to unlock or lock the door plate 500 with the support column 200 or the base 100. In this embodiment, a downwardly extending baffle is provided at an inner wall of the top frame 310 facing the side plate 400 and at a position corresponding to the door plate 500 to ensure that the door plate 500 only rotates outward to prevent the door plate 500 from rotating inward and disturbing a reptile in the reptile terrarium when there is a reptile in the reptile terrarium.

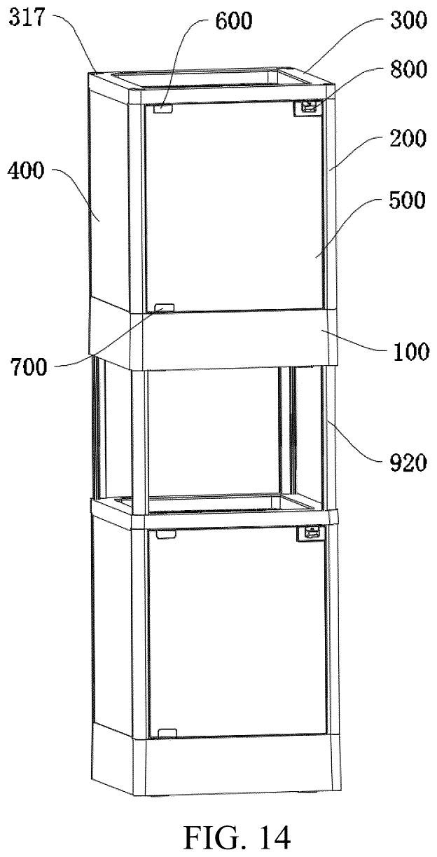

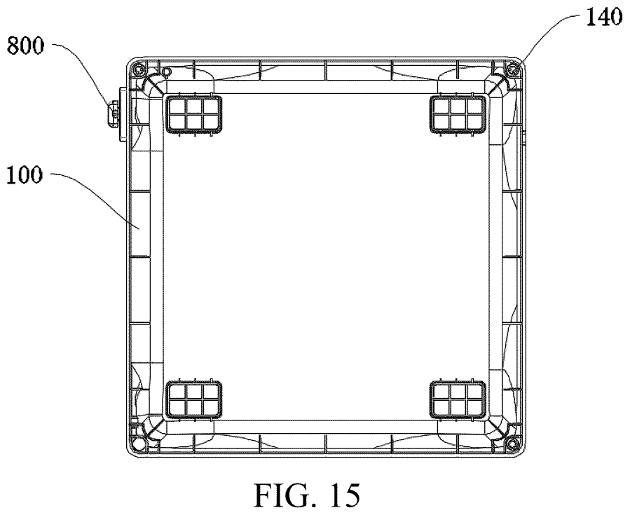

This embodiment also relates to a stackable reptile terrarium, referring to FIG. 3 and FIGS. 14 to 15, which includes: a plurality of the reptile terrariums and an upright column 920 detachably assembled between two adjacent reptile terrariums; wherein the reptile terrariums are placed up and down; a plurality of upright columns 920 are provided, one end of the upright column 920 is mounted on a bottom of the upper reptile terrarium and another end is mounted on a top of the lower reptile terrarium. Specifically, the top and bottom peripheral sides of each reptile terrarium are provided with a top assembly groove 316 and a bottom assembly groove 140 for the upright column 920 to be placed. In this embodiment, a buckle cover 317 corresponding to the top assembly groove 316 and detachably assembled is provided on the top assembly groove 316 of the reptile terrarium to prevent dust, flying debris and other debris from falling into the top assembly groove 316. In this embodiment, four top assembly grooves 316 and four bottom assembly grooves 140 are correspondingly formed on the top and bottom peripheral sides of each reptile terrarium, and four buckling covers 317 are correspondingly formed. In other embodiments, the number of the top assembly grooves 316 and the bottom assembly grooves 140 can be increased or decreased based on an actual requirement, and the number of the buckle covers 317 corresponds to the number of the top assembly grooves 316.

When needing to raise or splice a stackable reptile terrarium to accommodate a plurality of reptiles, the user only opens the buckle cover 317 of the top assembly groove 316 of the lower reptile terrarium, insert one end of the upright column 920, insert a plurality of upright columns 920 correspondingly on the surrounding side of the top of the lower reptile terrarium, and insert another end of the column 920 correspondingly into the bottom assembly groove 140 of the upper reptile terrarium. The assembly and disassembly process of the stackable reptile terrarium is simple and convenient, which is convenient for the user to assemble and disassemble independently, and is also convenient for transportation. The space enclosed by the upper reptile terrarium, the lower reptile terrarium and the upright column 920 ensures ventilation of the lower reptile terrarium and daily maintenance and cleaning of the lower reptile terrarium, and avoids the situation where the top of the lower reptile terrarium cannot be ventilated when a plurality of reptile terrariums are stacked, thereby affecting the reptiles in the lower reptile terrarium.

In other embodiments, the bottom assembly groove 140 of the reptile terrarium may also be provided with a buckle cover 317 corresponding to the bottom assembly groove 140 to prevent water or other debris from entering the bottom assembly groove 140.

### Embodiment 2

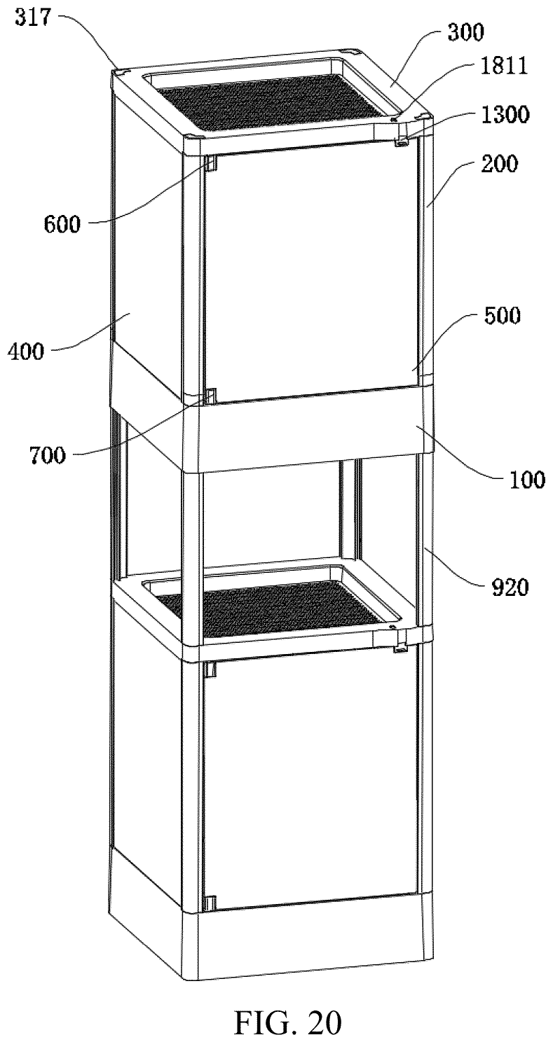

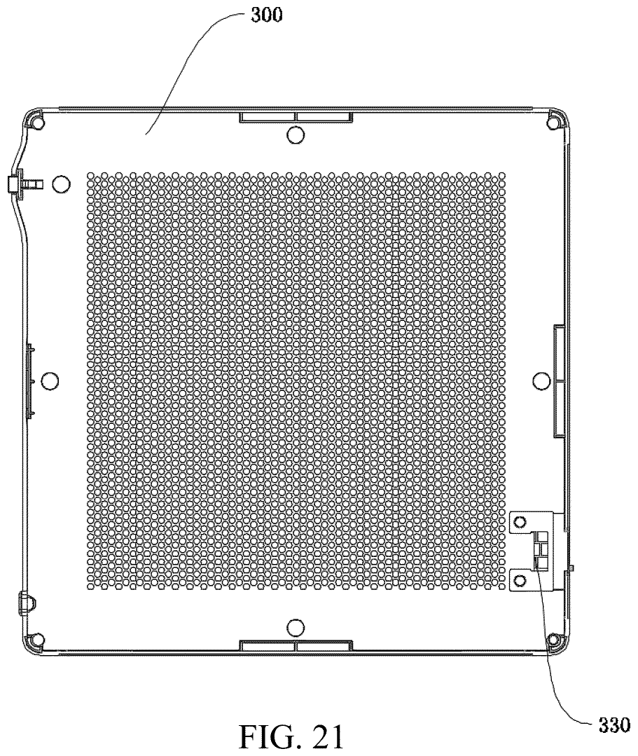

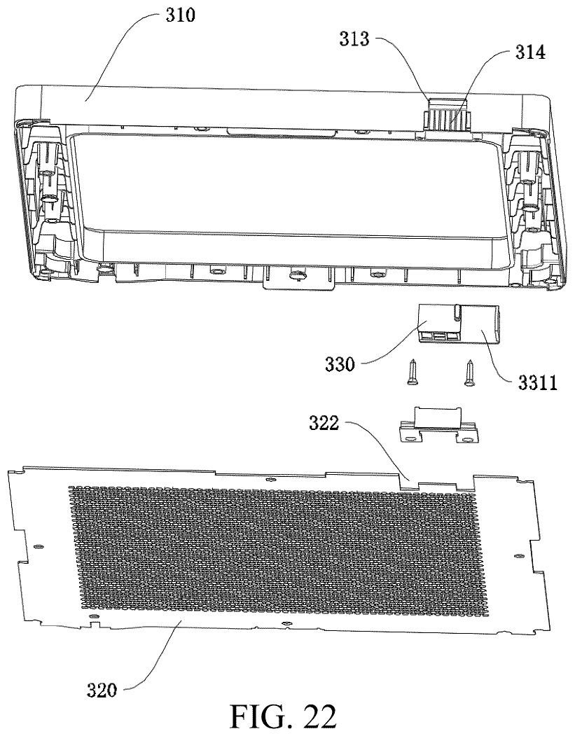

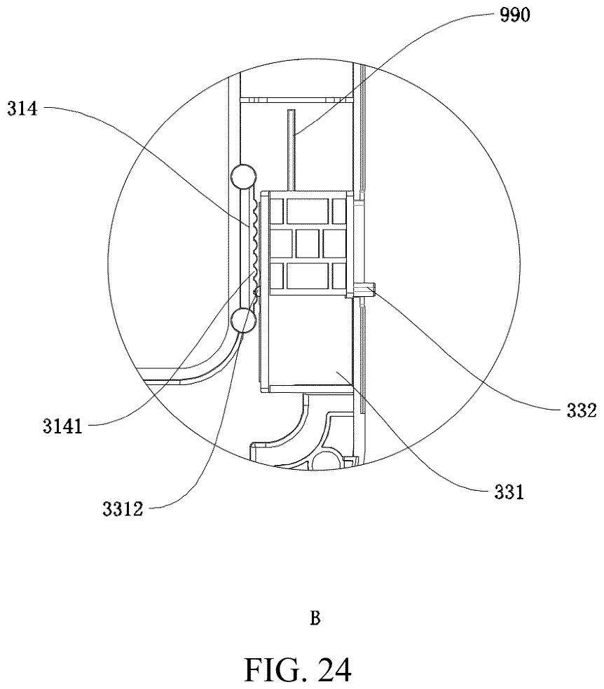

This embodiment is substantially the same as Embodiment 1 except that: in this embodiment, referring to FIGS. 20 to 24, a first through hole 313 is formed on a side surface of the top frame 310; a side surface of the slider 331 is connected to a bottom surface thereof and is provided with a second through hole 3311, and the ventilation plate 320 is correspondingly provided with a third through hole 322 connected to the first through hole 313 and the second through hole 3311.

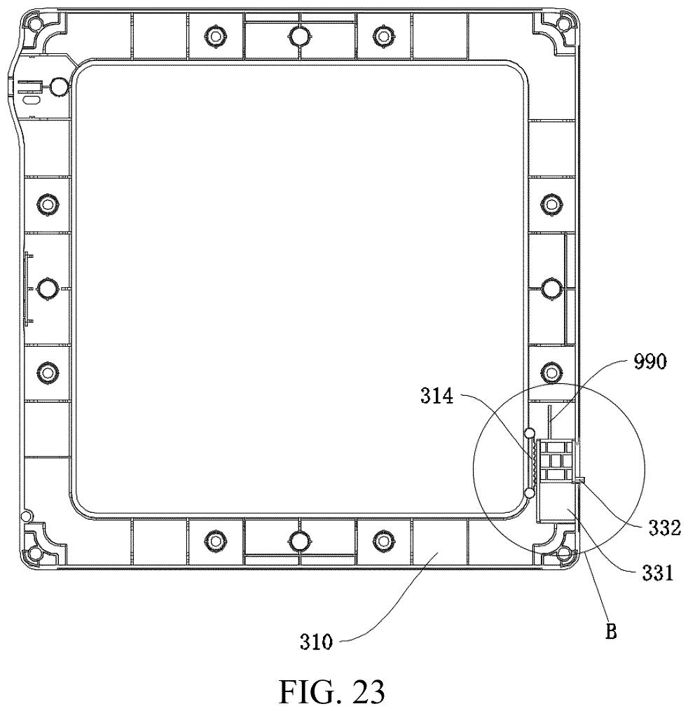

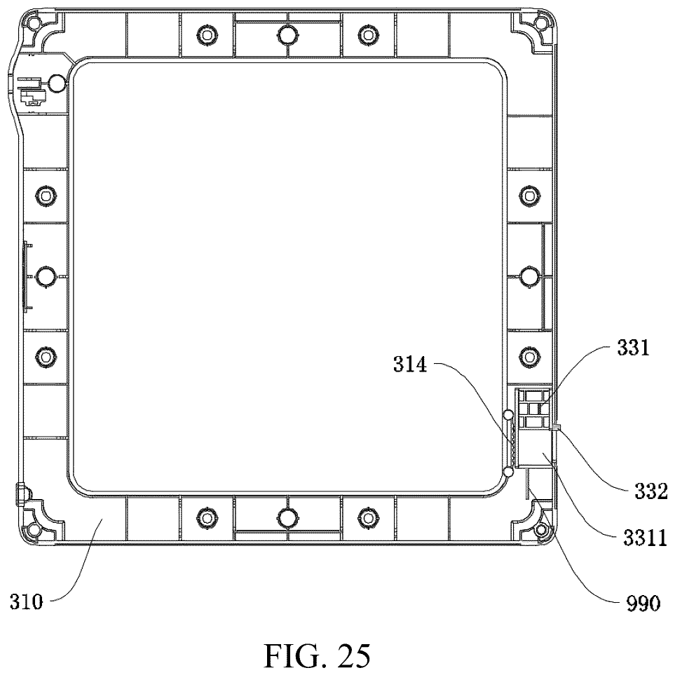

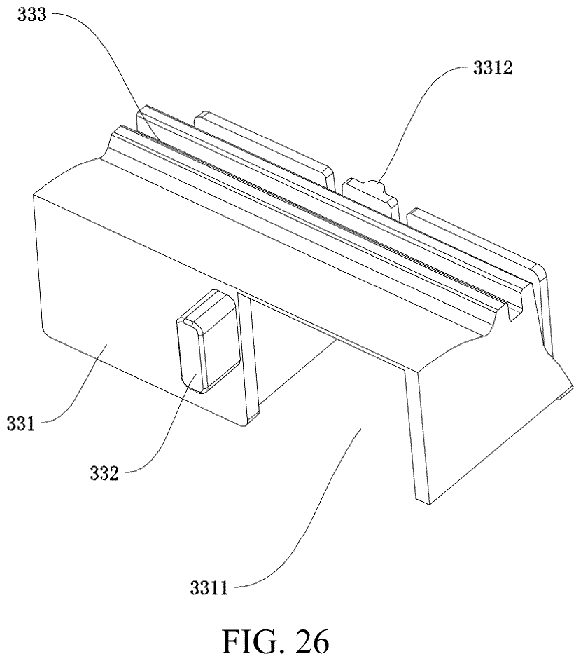

Further, referring to FIGS. 23 to 26, a sliding rail 990 is arranged at one side of the top frame 310 facing the slider 331, and a sliding groove 333 cooperating with the sliding rail 990 is provided at one side of the slider 331 facing the top frame 310; and the sliding rail 990 cooperates with the sliding groove 333 to limit a sliding track of the slider 331. In this embodiment, there is no need to provide a second stroke plate 315, and there is no need to provide the slider 331 with a limit stopper 3313 corresponding to the limiting groove 3151.

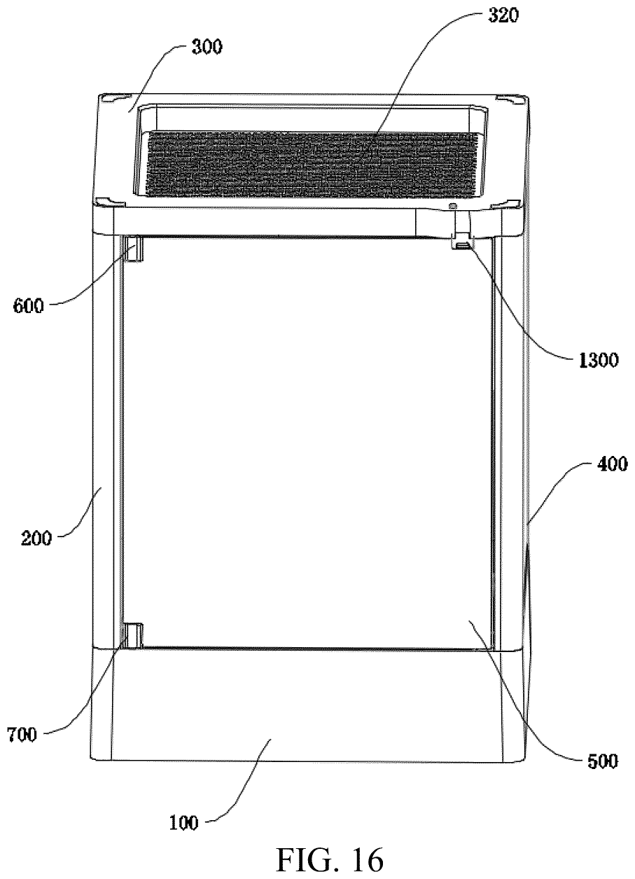

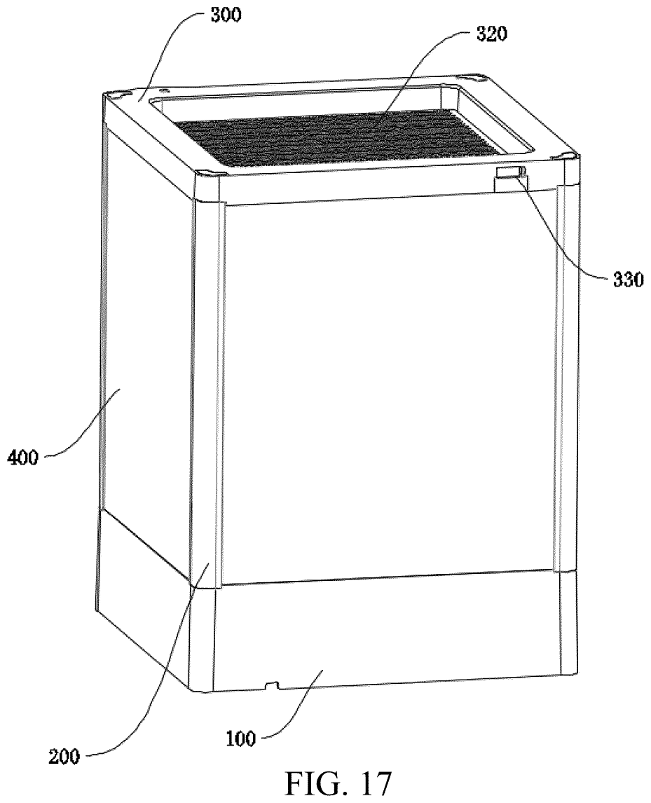

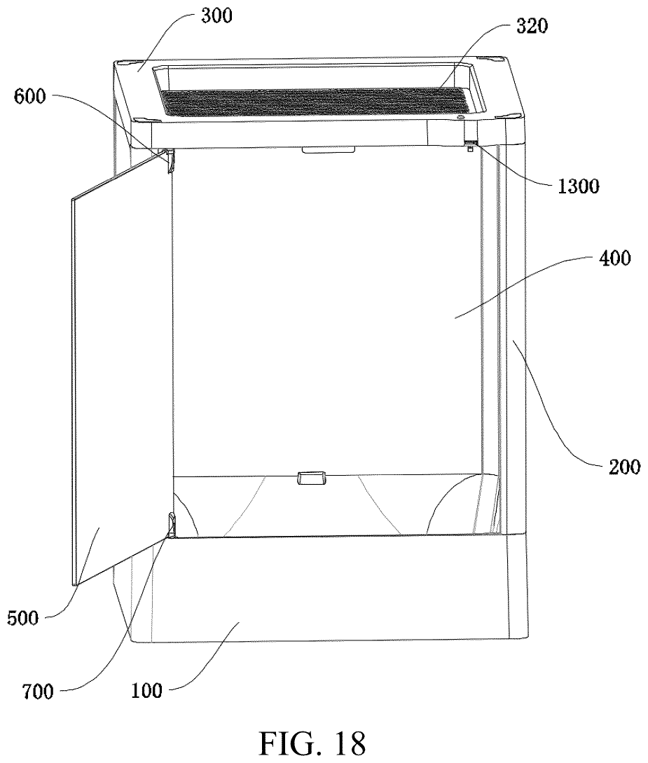

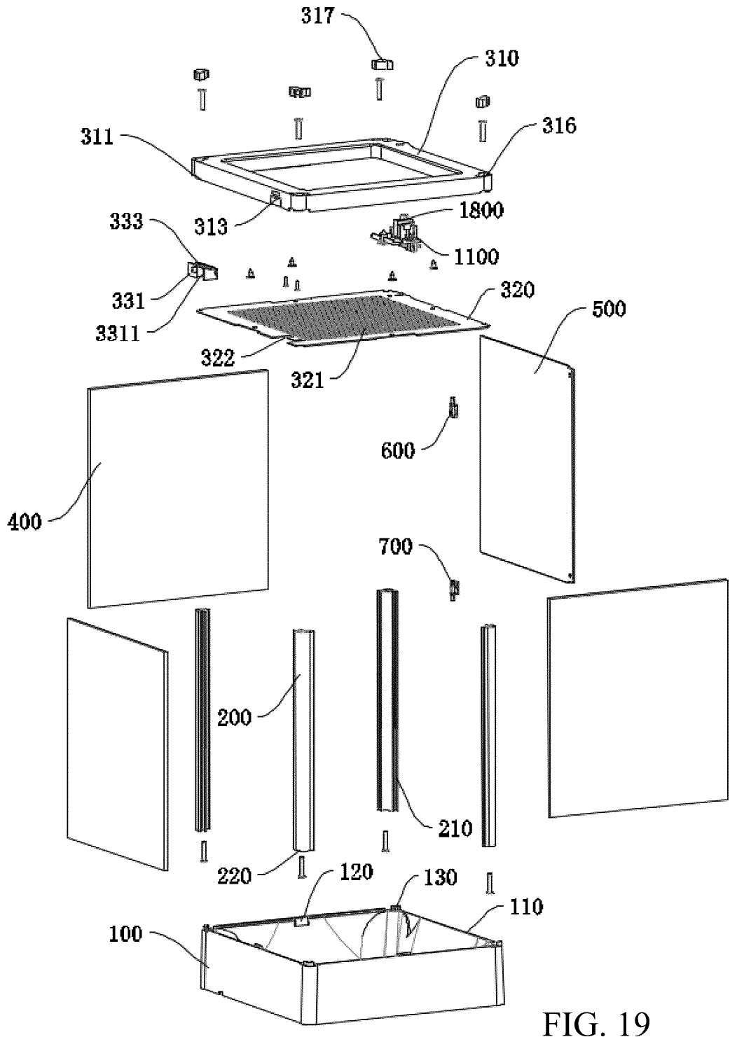

In addition, in this embodiment, the specific structure of the first rotating assembly 600 is also different from that in Embodiment 1. Referring to FIGS. 16 to 20 and FIG. 27, the first rotating assembly 600 may further include: a first mounting member 930, an assembly column 940, an extension member 950, a rotating shaft 960, a second mounting member 970, and a locking member 980. The first mounting member 930 is provided at an outer side of the door plate 500; the assembly column 940 is provided on one surface of the first mounting member 930 facing the door plate 500 and is used to assemble the first mounting member 930 on the door plate 500; the extension member 950 is provided on an upper side of the first mounting member 930, extends toward the door plate 500 and is overlapped on an upper edge of the door plate 500; the rotating shaft 960 is provided at a top side of the extension member 950 close to a rotating end, extends toward the top frame 310 and is used to be rotatably assembled with the top frame 310; the second mounting member 970 is provided on an inner side of the door plate 500 and is used to cooperate with the first mounting member 930 to drive the door plate 500 to rotate; and the locking member 980 is used to cooperate with the mounting column 940 to lock the first mounting member 930, the second mounting member 970 and the door plate 500. The first mounting member 930, the assembly column 940, the extension member 950, the rotating shaft 960, the second mounting member 970 and the locking member 980 cooperate to allow the door plate 500 to be rotated flexibly, so that the overall installation is convenient. In this embodiment, the structure of the second rotating assembly 700 is the same as that of the first rotating assembly 600, and also includes: a first mounting member, an assembly column, an extension member, a rotating shaft, a second mounting member, and a locking member.

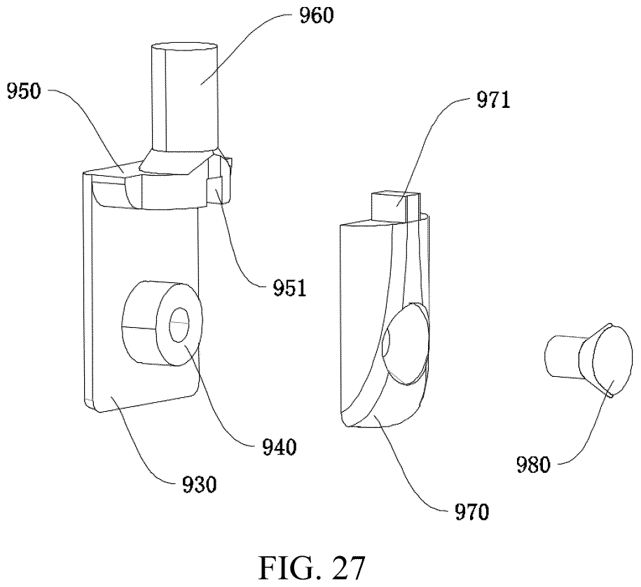

Further, referring to FIG. 27, an assembly groove 951 is formed on the extension member 950, and an assembly protrusion 971 cooperating with the assembly groove 951 is arranged on the second mounting member 970; and the assembly groove 951 cooperates with the assembly protrusion 971, so that the extension member 950 is in clamping fit with the second mounting member 970. The cooperation between the assembly groove 951 and the assembly protrusion 971 can accurately determine the relative position of the extension member 950 and the second mounting member 970, ensuring the accuracy of the installation. During the assembly process, the extension member 950 and the second mounting member 970 can be assembled by simply aligning the assembly protrusion 971 with the assembly groove 951 for snap connection, and then the first mounting member 930, the second mounting member 970 and the door plate 500 may be locked by the locking member 980 and the assembly column 940.

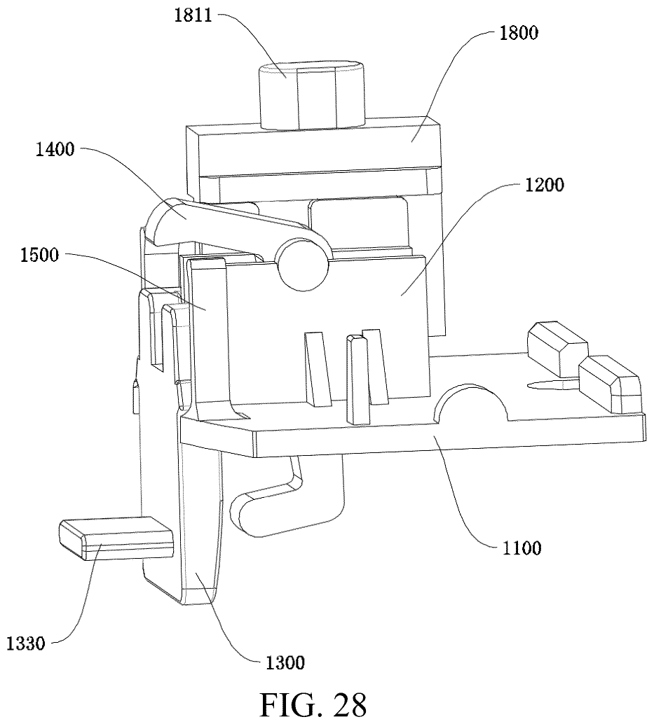

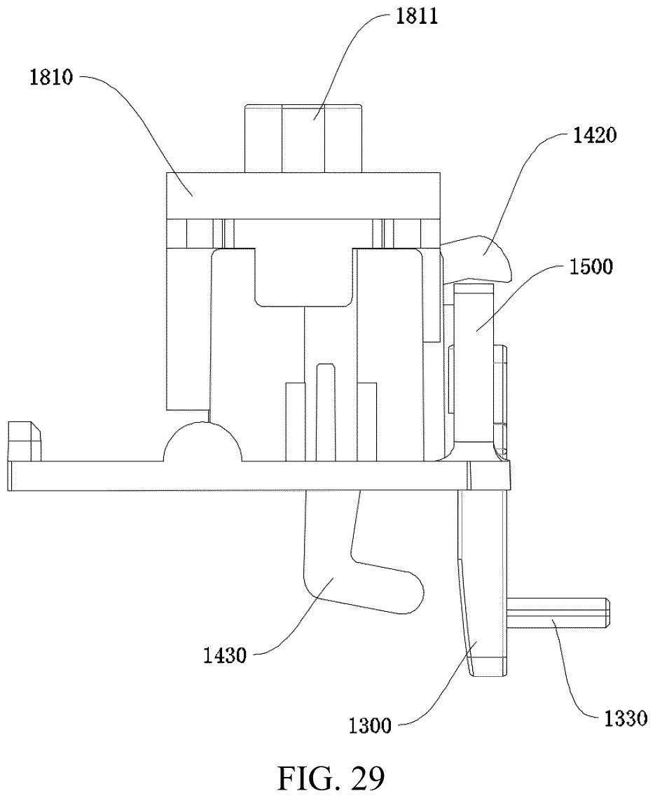

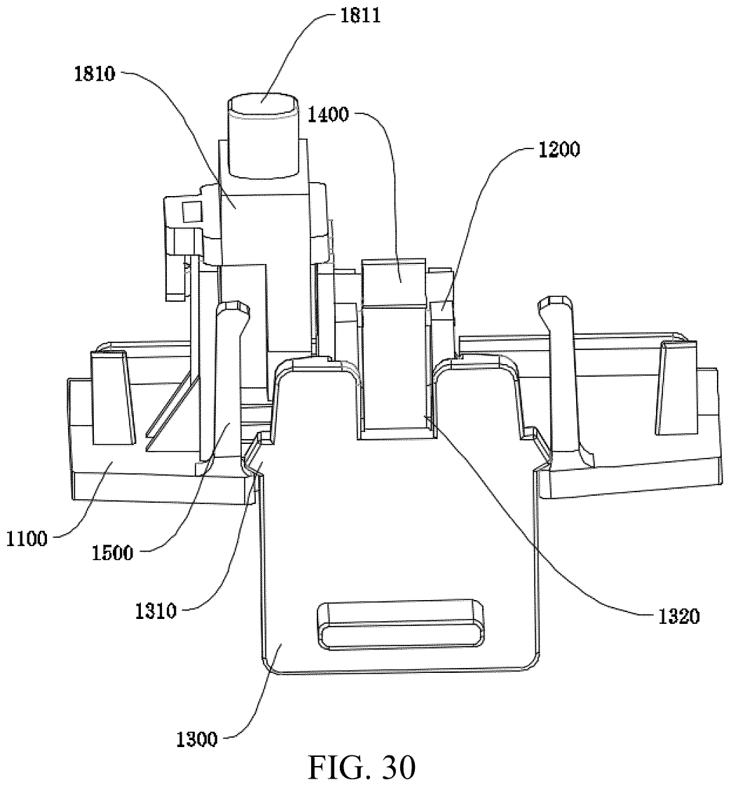

Referring to FIGS. 16 to 18, in this embodiment, there is no need to provide a locking switch 800 at the free end of the door plate 500, but the door plate 500 is locked by a door lock assembly. Specifically, the reptile terrarium also includes: a door lock assembly assembled between the free end of the door plate 500 and the top plate 300 or the base 100. Refer to FIGS. 28 to 30, the door lock assembly includes: a mounting plate 1100, a first support plate 1200, a latch bolt 1300 and a linkage member 1400. The linkage member 1400 includes: a linkage member body 1410, a first bending part 1420 and a second bending part 1430. One side of the mounting plate 1100 is provided with a movable hole 1110. The movable hole 1110 ensures that the second bending part 1430 has enough space for rotation. The first support plate 1200 is arranged on the mounting plate 1100 and positioned at two sides of the movable hole 1110. The latch bolt 1300 is movably assembled at one side of the first support plate 1200, and the latch bolt 1300 reciprocates along one side of the first support plate 1200. The linkage member body 1410 is rotatably assembled on the first support plate 1200, the first bending part 1420 is arranged at one end of the linkage member body 1410 and bends toward one side of the latch bolt 1300, and the second bending part 1430 is arranged at another end of the linkage member body 1410 and passes through the movable hole 1110 and extends away from the mounting plate 1100. A tail end of the second bending part 1430 bends toward one side of the latch bolt 1300; and the second bending part 1430 cooperates with the latch bolt 1300 to unlock or lock the door plate.

When a user closes the door plate, the door plate 500 pushes the second bending part 1430 to rotate inwards, so that the first bending part 1420 pushes the latch bolt 1300 toward a direction far away from the mounting plate 1100, and the door plate 500 is locked between the latch bolt 1300 and the second bending part 1430.

When the latch bolt 1300 is pushed toward a direction of the first bending part 1420, the latch bolt 1300 pushes the first bending part 1420 to rotate inwards, so that the second bending part 1430 rotates outwards, and then the second bending part 1430 pushes the door plate 500 outwards to unlock the door plate.

Specifically, in this embodiment, two first support plates 1200 are provided and positioned at two sides of the movable hole 1110. The first bending part 1420 is positioned at a top side of the latch bolt 1300, the second bending part 1430 is close to a lower end of the latch bolt 1300, the latch bolt 1300 is movably assembled at one side of the first support plate 1200, and the latch bolt 1300 reciprocates up and down relative to the mounting plate 1100 along one side of the first support plate 1200. In some embodiments, four first support plates 1200 may also be provided.

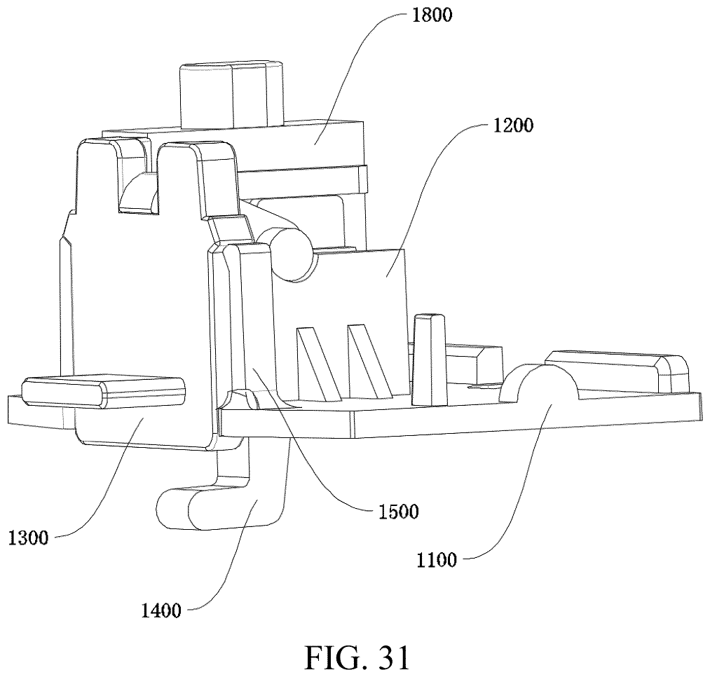

The operation of the user locking the door plate 500 is as follows: referring to FIGS. 28 to 31, when the user closes the door plate 500, the free end of the door plate 500 moves toward the door lock assembly, the free end of the door plate 500 abuts against the second bending part 1430, the door plate 500 pushes the second bending part 1430 to rotate inwards, and the first bending part 1420 and the second bending part 1430 are positioned at two sides of the linkage member body 1410 and both bend toward one side of the latch bolt 1300. The linkage member body 1410 is rotatably assembled on the first support plate 1200, so when the second bending part 1430 rotates inwards, the first bending part 1420 rotates outwards, specifically, the first bending part 1420 pushes the latch bolt 1300 in a direction far away from the mounting plate 1100. That is, the latch bolt 1300 falls down, and the door plate 500 is locked between the latch bolt 1300 and the second bending part 1430. In the process of locking the door plate 500, only the door plate 500 is closed, the free end of the door plate 500 pushes the second bending part 1430 to rotate, and the linkage member body 1410, the first bending part 1420 and the latch bolt 1300 may be linked, so that the door plate 500 may be self-locked, and the entire self-locking process is simple, convenient and quick, saving the user's time.

The operation of the user opening the door plate 500 is as follows: referring to FIGS. 28 to 31, when the door plate 500 is locked between the second bending part 1430 and the latch bolt 1300, the latch bolt 1300 is pushed toward the first bending part 1420 to push the latch bolt 1300 upward, so that the latch bolt 1300 does not limit the opening of the door plate 500. In the process of pushing the latch bolt 1300 toward the first bending part 1420, the latch bolt 1300 pushes the first bending part 1420 to rotate inwards, so that the second bending part 1430 rotates outwards, and the second bending part 1430 pushes the door plate 500 outwards to unlock the door plate 500. The entire unlocking process is simple, convenient and quick, and the first bending part 1420, the linkage member body 1410 and the second bending part 1430 may be linked only by pushing the latch bolt 1300 toward the first bending part 1420, so that the door plate 500 is unlocked.

The door lock assembly has a simple structure and does not require drilling holes on the door plate 500 to assemble other door lock assemblies, thereby eliminating processing costs such as drilling and achieving cost savings. Correspondingly, the reptile terrarium has the advantages of easy and quick unlocking and self-locking of the door plate 500 and a simple overall structure. Further, the door plate 500 is movably assembled between the top plate 300 and the base 100, and the door lock assembly is assembled between the free end of the door plate 500 and the top plate 300. Specifically, the door lock assembly is provided on the top plate 300. In the process of closing the door plate 500, the latch bolt 1300 may naturally drop under the effect of gravity, thereby achieving self-locking and facilitating locking the door plate 500. In other embodiments, the door plate 500 is movably assembled on the top plate 300 or the base 100, and the door lock assembly is assembled between the free end of the door plate 500 and the base 100.

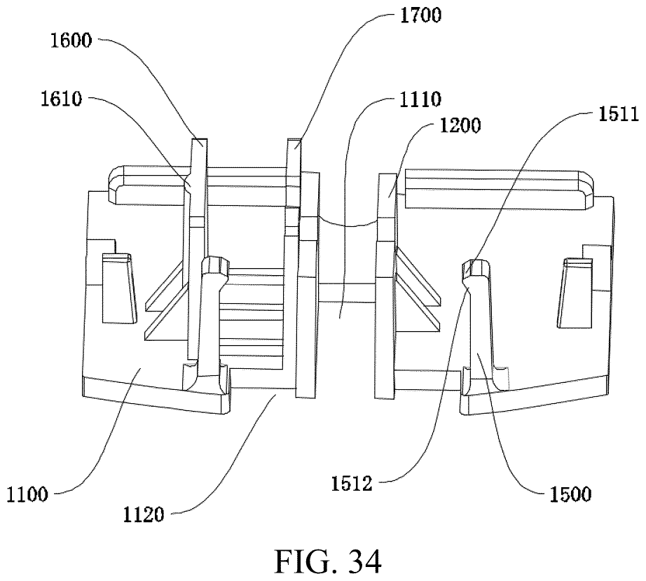

Further, referring to FIG. 34, a movable groove 1120 for the latch bolt 1300 to reciprocate is provided on the mounting plate 1100 and close to one side of the first support plate 1200. First limiting protrusions 1310 protruding toward two sides of the movable groove 1120 are provided at two sides of the latch bolt 1300; and the first limiting protrusion 1310 cooperates with the mounting plate 1100 to prevent the latch bolt 1300 from falling out. Meanwhile, the first limiting protrusion 1310 also prevents the latch bolt 1300 from moving excessively away from the first bending part 1420.

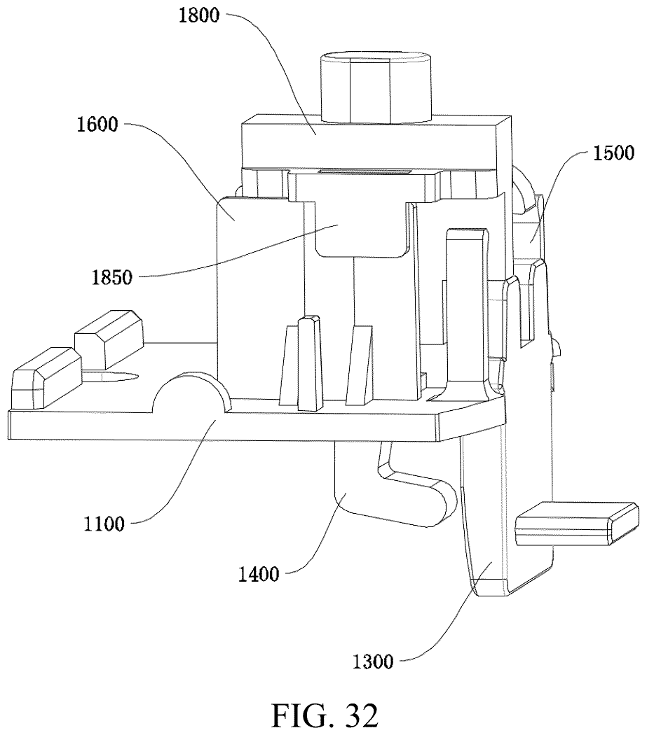

Further, referring to FIGS. 32 to 34, the mounting plate 1100 is provided with clamping columns 1500 extending away from the mounting plate 1100 on one side of the first support plate 1200 and at two sides of the movable groove 1120. The free end of the clamping column 1500 is provided with a second limiting protrusion 1510, and the first limiting protrusion 1310 and the second limiting protrusion 1510 cooperate to prevent the latch bolt 1300 from falling off and limit the movement of the door plate 500. That is, when the user needs to open the door plate 500, the latch bolt 1300 is moved until the first limiting protrusion 1310 on the latch bolt 1300 is engaged with the second limiting protrusion 1510 to prevent the latch bolt 1300 from obstructing the opening of the door plate 500. The second limiting protrusion 1510 protrudes toward between the limiting column 1500 and the other limiting column 1500. In this embodiment, a first guiding inclined surface 1311 is provided on one side of the first limiting protrusion 1310 close to the first bending part 1420, a second guiding inclined surface 1312 is provided on one side of the first limiting protrusion 1310 far away from the first bending part 1420, a third guiding inclined surface 1511 is provided on one side of the second limiting protrusion 1510 close to the mounting plate 1100, and a fourth guiding inclined surface 1512 is provided on one side of the second limiting protrusion 1510 far away from the mounting plate 1100. When the second guiding inclined surface 1312 abuts against one surface of the mounting plate 1100 where the limiting column 1500 is arranged, the latch bolt 1300 limits the door plate from rotating outward. When the second guiding inclined surface 1312 abuts against the fourth guiding inclined surface 1512, the latch bolt 1300 is positioned at the farthest position from the door plate 500, so as to avoid affecting the normal opening of the door plate 500. The first guiding inclined surface 1311 and the third guiding inclined surface 1511 are convenient for the first limiting protrusion 1310 and the second limiting protrusion 1510 to be smoothly clamped, so as to avoid the phenomenon that the latch bolt 1300 is stuck during the moving process.

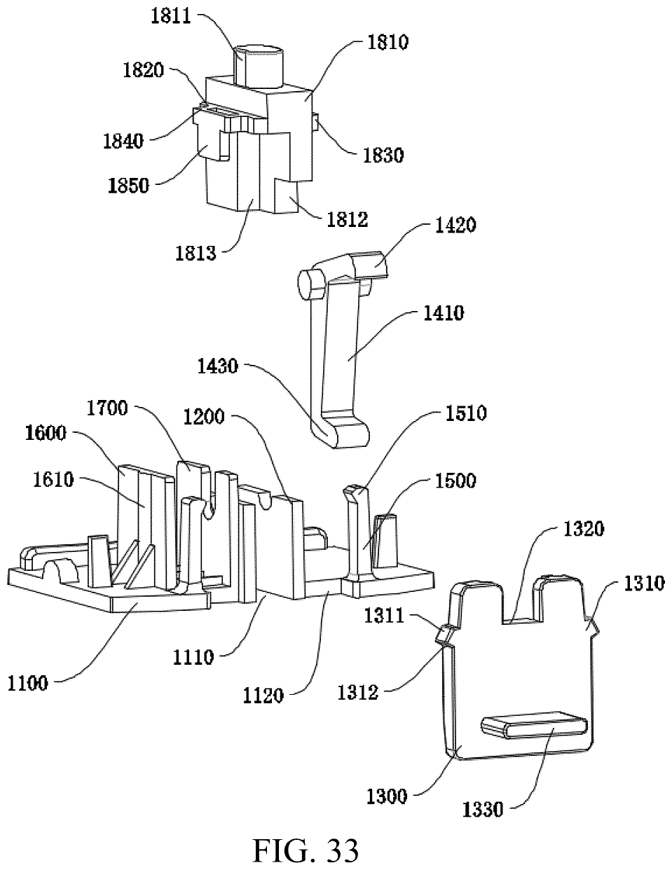

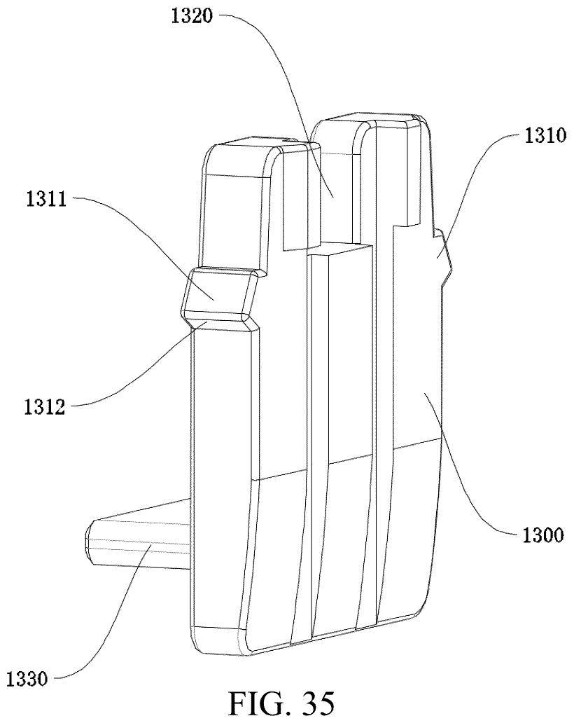

In this embodiment, referring to FIGS. 33 and 35, a first avoidance groove 1320 recessed toward a direction far away from the first bending part 1420 is formed on one side of the latch bolt 1300 close to the first bending part 1420. The design of the first avoidance groove 1320 ensures that the latch bolt 1300 has a sufficient moving space, thereby preventing the latch bolt 1300 from affecting the opening of the door plate 500 due to the latch bolt not rising in place.

Further, a handle 1330 is provided at one side of the latch bolt 1300 opposite to the mounting plate 1100, that is, the handle 1330 is provided on an outer side of the latch bolt 1300, so that a user can grasp the handle to control the moving direction of the latch bolt 1300, and the user can operate the latch bolt more easily and conveniently.

In some embodiments, referring to FIGS. 33 to 34, this door lock assembly further includes: a second support plate 1600, a third support plate 1700 and a limiting member 1800. The second support plate 1600 is arranged on the mounting plate 1100 and close to one side of the latch bolt 1300. The third support plate 1700 is arranged on the mounting plate 1100 and close to one side of the latch bolt 1300. The limiting member 1800 is slidably assembled between the second support plate 1600 and the third support plate 1700. The limiting member 1800 is used to limit the movement of the latch bolt 1300 toward the first bending part 1420. When the first limiting protrusion 1310 is clamped on the mounting plate 1100, the limiting member 1800 slides toward the top side of the latch bolt 1300, so that the bottom surface of the limiting member 1800 abuts against the top surface of the latch bolt 1300, which prevents the latch bolt 1300 from moving toward the first bending part 1420, further enhances the safety of the door plate 500 in the locked state and reduces the risk of accidental unlocking of the door plate 500.

In some embodiments, referring to FIG. 33, the top surface of the limiting member 1800 may further be provided with a button protrusion 1811, so that a user can move the limiting member 1800 toward the top side of the locking bolt 1300 by pushing the button protrusion 1811, thereby limiting the movement of the locking bolt 1300 toward the first bending part 1420. The button protrusion 1811 facilitates user operation.

Further, referring to FIGS. 32 to 33, a limiting groove of the latch bolt 1300 is formed at one side of the limiting member 1800 close to the latch bolt 1300. When the first limiting protrusion 1310 is clamped on the mounting plate 1100, the limiting member 1800 slides toward the latch bolt 1300, so that one end of the latch bolt 1300 is placed in the limiting groove of the latch bolt 1300. That is, a bottom surface of the limiting groove of the latch bolt 1300 abuts against the top surface of one end of the latch bolt 1300, so that the position of the latch bolt 1300 is accurately limited, the stability and the reliability of the door lock assembly in the working process are ensured, and the door plate is prevented from being unlocked accidentally due to the accidental movement of the latch bolt 1300.

In this embodiment, the second avoiding groove 1813 is further formed at the lower end of the limiting member 1800 and at one side close to the clamping column 1500, which prevents the design of the clamping column 1500 from limiting the movement of the limiting member 1800 when the limiting member 1800 moves toward the latch bolt 1300, thereby ensuring the smooth movement of the limiting member 1800.

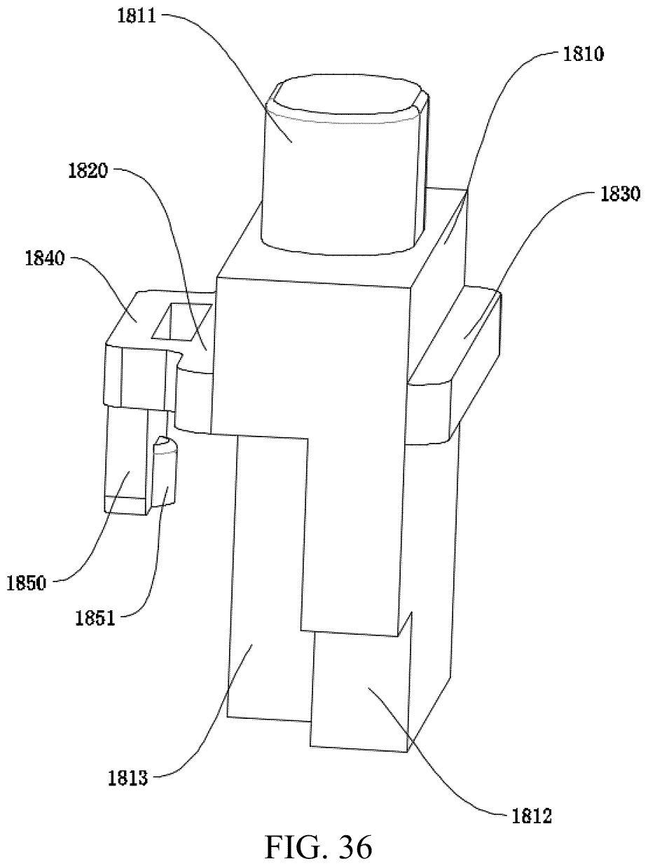

In this embodiment, referring to FIGS. 33 and 36, the limiting member 1800 includes: a limiting member body 1810, a first sliding bar 1820 and a second sliding bar 1830. The first sliding bar 1820 is arranged at one side of the limiting member body 1810, and the second sliding bar 1830 is arranged at another side of the limiting member body 1810. The first sliding bar 1820 and the second sliding bar 1830 are slidably assembled on the second support plate 1600 and the third support plate 1700, respectively; the first sliding bar 1820 cooperates with the second sliding bar 1830 to enable the limiting member body 1810 to slide relative to the second support plate 1600 and the third support plate 1700. Specifically, the first sliding bar 1820 and the second sliding bar 1830 are slidably assembled on the top side of the second support plate 1600 and the top side of the third support plate 1700, respectively. The first sliding bar 1820 and the second sliding bar 1830 ensure that the limiting member body 1810 can smoothly slide relative to the second support plate 1600 and the third support plate 1700.

Further, referring to FIG. 36, a first extension plate 1840 extending away from the limiting member body 1810 is provided at one side of the first sliding bar 1820 far away from the limiting member body 1810; a second extension plate 1850 vertically extending toward the mounting plate 1100 is provided on a bottom side of the first extension plate 1840; a first arc-shaped protrusion 1851 is provided at one side of the second extension plate 1850 facing the second support plate 1600; and a second arc-shaped protrusion 1610 cooperating with the first arc-shaped protrusion 1851 is provided at one side of the second support plate 1600 facing away from the third support plate 1700. The first arc-shaped protrusion 1851 and the second arc-shaped protrusion 1610 cooperate to play a buffering and limiting role during the sliding process of the limiting member body 1810, thereby preventing the limiting member body 1810 from sliding accidentally due to external force, which causes the latch bolt 1300 to move, and ultimately causes the door plate to be accidentally unlocked or locked and affects the user's normal use.

The above description is only intended to illustrate the technical solution of the present invention and not to limit the present invention, and other modifications or equivalent substitutions made by those skilled in the art to the technical solution of the present invention should be covered by the scope of the claims of the present invention without departing from the spirit and scope of the technical solution of the present invention.

What is claimed is:

1. A reptile terrarium, comprising:
a base (100), having an open top, wherein an inner side wall of the base (100) is provided as an inclined surface inclined toward the inside of the base (100);
a support column (200), detachably assembled on an upper peripheral side of the base (100), wherein a plurality of the support columns (200) are provided, and first clamping grooves (210) are provided at two sides of each support column (200);
a side plate (400), detachably assembled between two adjacent support columns (200), wherein two sides of the side plate (400) are placed in corresponding first clamping grooves (210), and a plurality of the side plates (400) are provided;
a top plate (300), detachably assembled at one end of the support column (200) far away from the base (100), wherein the top plate (300) is provided with ventilation holes (321); and
a door plate (500), positioned between two adjacent support columns (200), movably assembled between the top plate (300) and/or the base (100), and used to open or close the reptile terrarium.

2. The reptile terrarium according to claim 1, wherein a first limit stop bar (110) extending upward is provided on one surface of the base (100) abutting against the side plate (400), a first limit stop plate (120) is provided on an inner side wall of one end of the base (100) close to the side plate (400), and the first limit stop bar (110) cooperates with the first limit stop plate (120) to prevent the side plate (400) from tipping over.

3. The reptile terrarium according to claim 2, wherein a second limit stop bar (311) extending downward is provided on one surface of the top plate (300) facing the side plate (400), a second limit stop plate (312) is provided on an inner side wall of one surface of the top plate (300) facing the side plate (400), and the second limit stop bar (311) cooperates with the second limit stop plate (312) to prevent the side plate (400) from tipping over.

4. The reptile terrarium according to claim 1, wherein a second clamping groove (220) is provided at one end of the support column (200) facing the base (100), a limiting column (130) corresponding to the second clamping groove (220) is provided on the base (100), and the second clamping groove (220) cooperates with the limiting column (130) to fix the support column (200) at a set position.

5. The reptile terrarium according to claim 1, wherein the top plate (300) comprises: a top frame (310), a ventilation plate (320) fixedly assembled on the top frame (310) facing the support column (200) and having a plurality of ventilation holes (321), and an opening component (330) slidably assembled on the top frame (310) facing the ventilation plate (320); the opening component (330) comprises: a slider (331) and a slider protrusion (332) provided on one surface of the slider (331) facing the top frame (310); the top frame (310) is provided with a first through hole (313), the slider protrusion

(332) is exposed from the first through hole (313), the slider (331) is provided with a second through hole (3311), and the ventilation plate (320) is provided with a third through hole (322) corresponding to the position of the first through hole (313); and
when the slider protrusion (332) is pushed and the slider (331) slides to a set position, the first through hole (313), the second through hole (3311), and the third through hole (322) are connected to form an opening channel.

6. The reptile terrarium according to claim 5, wherein a first stroke plate (314) is provided at one surface of the top frame (310) facing the ventilation plate (320) and positioned at one side of the first through hole (313), the first stroke plate (314) is provided with a plurality of arc-shaped grooves (3141) in succession, and the slider (331) is provided with an elastic protrusion (3312);
and the elastic protrusion (3312) cooperates with the arc-shaped groove (3141) to limit an opening width of the opening channel.

7. The reptile terrarium according to claim 6, wherein a second stroke plate (315) is provided at one surface of the top frame (310) facing the ventilation plate (320) and positioned at another side of the first through hole (313), and the second stroke plate (315) is provided with a limiting groove (3151); the slider (331) is also provided with a limit stopper (3313) corresponding to the limiting groove (3151), and the limiting groove (3151) cooperates with the limit stopper (3313) to limit a sliding range of the slider (331).

8. The reptile terrarium according to claim 6, wherein a sliding rail (990) is arranged at one side of the top frame (310) facing the slider (331), and a sliding groove (333) cooperating with the sliding rail (990) is provided at one side of the slider (331) facing the top frame (310); and the sliding rail (990) cooperates with the sliding groove (333) to limit a sliding track of the slider

(331) .

9. The reptile terrarium according to claim 5, wherein one end of the door plate (500) is rotatably connected to the top frame (310) by a first rotating assembly (600), another end is rotatably connected to the base (100) by a second rotating assembly (700), and the first rotating assembly (600) and the second rotating assembly (700) are arranged on the same vertical line.

10. The reptile terrarium according to claim 9, wherein the first rotating assembly (600) comprises: a fixed plate (610) provided at an outer side of the door plate (500), a mounting column (620) provided on one surface of the fixed plate (610) facing the door plate (500) and used to mount the fixed plate (610) on the door plate (500), an extension plate (630) provided on an upper side of the fixed plate (610) and overlapped on an upper edge of the door plate (500), a rotation shaft (640) provided close to a rotating end of the extension plate (630), extending toward one surface of the top frame (310) and used to rotate with the top frame (310), a shaft sleeve (650) provided at a peripheral side of the rotation shaft (640), and a fastener (660) used to cooperate with the mounting column (620) to assemble the fixed plate (610) on the door plate (500).

11. The reptile terrarium according to claim 9, wherein the first rotating assembly (600) comprises: a first mounting member (930) provided at an outer side of the door plate (500), an assembly column (940) provided on one surface of the first mounting member (930) facing the door plate (500) and used to assemble the first mounting member (930) on the door plate (500), an extension member (950) provided on an upper side of the first mounting member (930), extending toward the door plate (500) and overlapped on an upper edge of the door plate (500), a rotating shaft (960) provided at a top side of the extension member (950) close to a rotating end, extending toward the top frame (310) and used to be rotatably assembled with the top frame (310), a second mounting member (970) provided on an inner side of the door plate (500) and used to cooperate with the first mounting member (930) to drive the door plate (500) to rotate, and a locking member (980) used to cooperate with the mounting column (940) to lock the first mounting member (930), the second mounting member (970) and the door plate (500).

12. The reptile terrarium according to claim 11, wherein an assembly groove (951) is formed on the extension member (950), and an assembly protrusion (971) cooperating with the assembly groove (951) is arranged on the second mounting member; and the assembly groove (951) cooperates with the assembly protrusion (971), so that the extension member (950) is in clamping fit with the second mounting member (970).

13. The reptile terrarium according to claim 1, wherein the reptile terrarium further comprises: a door lock assembly assembled between a free end of the door plate (500) and the top plate (300) or the base (100), and the door lock assembly comprises:
a mounting plate (1100), wherein a movable hole (1110) is formed at one side of the mounting plate (1100);
a first support plate (1200), arranged on the mounting plate (1100) and positioned at two sides of the movable hole (1110);
a latch bolt (1300), movably assembled at one side of the first support plate (1200), wherein the latch bolt (1300) reciprocates along one side of the first support plate (1200); and
a linkage member (1400); wherein the linkage member (1400) comprises: a linkage member body (1410) rotatably assembled on the first support plate (1200), a first bending part (1420) provided at one end of the linkage member body (1410) and bending toward one side of the latch bolt (1300), and a second bending part (1430) provided at another end of the linkage member body (1410), passing through the movable hole (1110) and extending toward a direction far away from the mounting plate (1100); a tail end of the second bending part (1430) bends toward one side of the latch bolt (1300); the second bending part (1430) cooperates with the latch bolt (1300) to unlock or lock the door plate;
when a user closes the door plate (500), the door plate (500) pushes the second bending part (1430) to rotate inwards, so that the first bending part (1420) pushes the latch bolt (1300) toward a direction far away from the mounting plate (1100), and the door plate (500) is locked between the latch bolt (1300) and the second bending part (1430); and
when the latch bolt (1300) is pushed towards a direction of the first bending part (1420), the latch bolt (1300) pushes the first bending part (1420) to rotate inwards, so that the second bending part (1430) rotates outwards, and then the second bending part (1430) pushes the door plate

(500) outwards to unlock the door plate (500).

14. The reptile terrarium according to claim 13, wherein a movable groove (1120) for the latch bolt (1300) to reciprocate is provided at one side of the mounting plate (1100) close to the first support plate (1200); first limiting protrusions (1310) protruding toward two sides of the movable groove (1120) are provided at two sides of the latch bolt (1300); and the first limiting protrusion (1310) cooperates with the mounting plate (1100) to prevent the latch bolt (1300) from falling out.

15. The reptile terrarium according to claim 13, wherein the door lock assembly further comprises: a second support plate (1600) provided on the mounting plate (1100) and close to one side of the latch bolt (1300), a third support plate (1700) provided on the mounting plate (1100) and close to one side of the latch bolt (1300), and a limiting member (1800) slidably assembled between the second support plate (1600) and the third support plate (1700); and the limiting member (1800) is used to limit the movement of the latch bolt (1300) toward the first bending part (1420).

16. The reptile terrarium according to claim 13, wherein a latch bolt limiting groove (1812) is provided at one side of the limiting member (1800) close to the latch bolt (1300).

17. The reptile terrarium according to claim 13, wherein the limiting member (1800) comprises: a limiting member body (1810), a first sliding bar (1820) provided at one side of the limiting member body (1810) and a second sliding bar (1830) provided at another side of the limiting member body (1810); the first sliding bar (1820) and the second sliding bar (1830) are slidably assembled on the second support plate (1600) and the third support plate (1700) respectively; and the first sliding bar (1820) cooperates with the second sliding bar (1830), so that the limiting member body (1810) slides relative to the second support plate (1600) and the third support plate (1700).

18. The reptile terrarium according to claim 17, wherein a first extension plate (1840) extending away from the limiting member body (1810) is provided at one side of the first sliding bar (1820) far away from the limiting member body (1810); a second extension plate (1850) vertically extending toward the mounting plate (1100) is provided on a bottom side of the first extension plate (1840); a first arc-shaped protrusion (1851) is provided at one side of the second extension plate (1850) facing the second support plate (1600); and a second arc-shaped protrusion (1610) cooperating with the first arc-shaped protrusion (1851) is provided at one side of the second support plate (1600) facing away from the third support plate (1700).

19. A stackable reptile terrarium, comprising: a plurality of the reptile terrariums according to claim 1 and an upright column (920) detachably assembled between two adjacent reptile terrariums; wherein the reptile terrariums are placed up and down; a plurality of the upright columns (920) are provided, one end of the upright column (920) is mounted on a bottom of the upper reptile terrarium and another end is mounted on a top of the lower reptile terrarium.
